(19) United States
(12) Patent Application Publication
(10) Pub. No.: US 2026/0057470 A1
(43) Pub. Date: Feb. 26, 2026

(54) DYNAMIC GRAPHICS WORKLOAD SUBMISSION

(71) Applicant: QUALCOMM Incorporated, San Diego, CA (US)

(72) Inventors: Sanjeevi S, Bangalore (IN); Nawneet KUMAR, Bangalore (IN); Rakshit JOSHI, Almora (IN); Avinash JAIN, Ghaziabad (IN)

(21) Appl. No.: 18/814,034

(22) Filed: Aug. 23, 2024

(51) Int. Cl. G06T 1/20

(52) U.S. Cl. CPC G06T 1/20

(57) ABSTRACT

Aspects presented herein relate to methods and devices for graphics processing including an apparatus, e.g., a central processor. The apparatus may monitor a first set of graphics workloads that were previously submitted to a graphics processor. The apparatus may also determine whether a status of each of the first set of graphics workloads is completed or executed at the graphics processor. Further, the apparatus may output, based on the status of at least one graphics workload in the first set of graphics workloads being completed or executed at the graphics processor, an indication of a second set of graphics workloads to the graphics processor.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor or display processing unit (DPU).

A graphics processor of a device may be configured to perform the processes in a graphics processing pipeline. Further, graphics processors may be utilized to store and process data including workloads. However, there has developed an increased need for improved workload submission in graphics processing.

### BRIEF SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a central processing unit (CPU), a graphics processor, a graphics processing unit (GPU), or any apparatus that may perform for graphics processing. The apparatus may receive, prior to monitoring a first set of graphics workloads, a set of application programming interface (API) calls associated with the first set of graphics workloads. The apparatus may also configure a set of register programs for each of the set of API calls associated with the first set of graphics workloads, where the set of register programs is to be executed at the graphics processor. The apparatus may also store, in a command buffer, the set of register programs for each of the set of API calls associated with the first set of graphics workloads. Additionally, the apparatus may output, to a graphics processor, a first indication of the first set of graphics workloads prior to monitoring the first set of graphics workloads. The apparatus may also monitor a first set of graphics workloads that were previously submitted to a graphics processor. Moreover, the apparatus may determine whether a status of each of the first set of graphics workloads is completed or executed at the graphics processor. The apparatus may also configure, based on the status of at least one graphics workload of the first set of graphics workloads being completed or executed at the graphics processor, a command for each of the second set of graphics workloads prior to outputting the command for each of the second set of graphics workloads. The apparatus may also output, based on the status of at least one graphics workload in the first set of graphics workloads being completed or executed at the graphics processor, an indication of a second set of graphics workloads to the graphics processor. Further, the apparatus may output, based on storage of the command for each of the second set of graphics workloads, a second indication of an address of the command buffer for each of the second set of graphics workloads.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example graphics processing unit (GPU) in accordance with one or more techniques of this disclosure.

FIG. 3 is a diagram illustrating example processing components in accordance with one or more techniques of this disclosure.

FIG. 4 is a diagram illustrating an example geometry pipeline in accordance with one or more techniques of this disclosure.

FIG. 5 is a diagram illustrating an example GPU hardware in accordance with one or more techniques of this disclosure.

FIG. 6 is a diagram illustrating an example execution sequence in accordance with one or more techniques of this disclosure.

FIG. 7 is a diagram illustrating an example workload processing sequence in accordance with one or more techniques of this disclosure.

FIG. 8 is a diagram illustrating an example workload processing sequence in accordance with one or more techniques of this disclosure.

FIG. 9 is a communication flow diagram illustrating example communications between a CPU, a GPU, and a memory in accordance with one or more techniques of this disclosure.

FIG. 10 is a flowchart of an example method of graphics processing in accordance with one or more techniques of this disclosure.

FIG. 11 is a flowchart of an example method of graphics processing in accordance with one or more techniques of this disclosure.

### DETAILED DESCRIPTION

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software may be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that may be accessed by a computer. By way of example, and not limitation, such computer-readable media may comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that may be used to store computer executable code in the form of instructions or data structures that may be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended. In some examples, as used herein, the term “graphics workload” may refer to any workload or order associated with graphics processing. In some examples, as used herein, the term “texture fetch” may refer to a memory request, which incurs transactions from a cache (e.g., a texture cache). Each time a warp executes a texture function to read from texture memory, this may be a single texture fetch. Also, texture memory may be read-only device memory, and may be accessed using the device functions described in a texture function. Reading a texture using one of these functions may be called a “texture fetch.”

In some applications or application programming interfaces (APIs) for graphics processing, a graphics workload submission can be controlled by a driver (e.g., a driver at a CPU, such as a graphics driver or a user mode driver (UMD)). The graphics workload submission may be scheduled based on a number of predefined conditions, such as a draw threshold (e.g., 1000 draws), memory space issues (e.g., video memory is out of space), etc. In these instances, the driver may have no option other than submitting the workload to the graphics processor or GPU. In the event that the driver submits a workload to the graphics processor or GPU, this may lead to inefficiencies, such as the suboptimal utilization of the graphics processor or GPU, as well as potential performance bottlenecks at the GPU or CPU. In some cases, if the GPU has completed all submissions, it may remain idle until the graphics driver or user mode driver (UMD) (e.g., a driver at the CPU) sends the next submission. For example, if the driver submits a workload and the GPU completes this quickly, the driver may keep building the next workload. So during this period, some portion of the GPU may be pending idle because the workload is already completed and the GPU may be waiting for the next workload from the driver. So in these instances, the GPU will remain paused and not be fully utilized, which can lead to suboptimal GPU utilization. Indeed, if the graphics driver or UMD continues to accumulate workloads while the GPU is idle, parallelism may not be achieved between the CPU and GPU (i.e., when the CPU and GPU are working in a parallel and efficient manner). This may result in CPU-GPU serialization (i.e., the CPU and GPU working in-line with each other or working one at-a-time), which wastes time and resources at the CPU and GPU. Aspects presented herein optimize the efficiency between a CPU and a GPU. For instance, aspects presented herein may monitor idle working periods at a GPU in order to optimize the efficiency between a CPU and GPU.

Aspects of the present disclosure may include a number of benefits or advantages. For instance, aspects presented herein may optimize the efficiency regarding graphics workloads between a CPU and a GPU. Additionally, aspects presented herein may achieve parallelism between the CPU and GPU (i.e., when a CPU and GPU are working in a parallel manner). Moreover, aspects presented herein may monitor idle working periods at a GPU in order to optimize the efficiency between a CPU and GPU. For instance, aspects presented herein may monitor graphics workloads that were previously submitted to a GPU and determine whether the graphics workloads are completed or executed at the GPU. By determining if the graphics workloads are completed or executed at the GPU, aspects presented herein may monitor the idle working periods at the GPU and increase the efficiency of the GPU and CPU. By doing so, aspects presented herein may help to increase the parallelism between a CPU and GPU (i.e., when the CPU and GPU are working in a parallel and efficient manner). Thus, aspects presented herein may help to keep the GPU active and avoid performance bottlenecks. Aspects presented herein may also improve the performance/speed of a GPU because the utilization of the GPU will be increased.

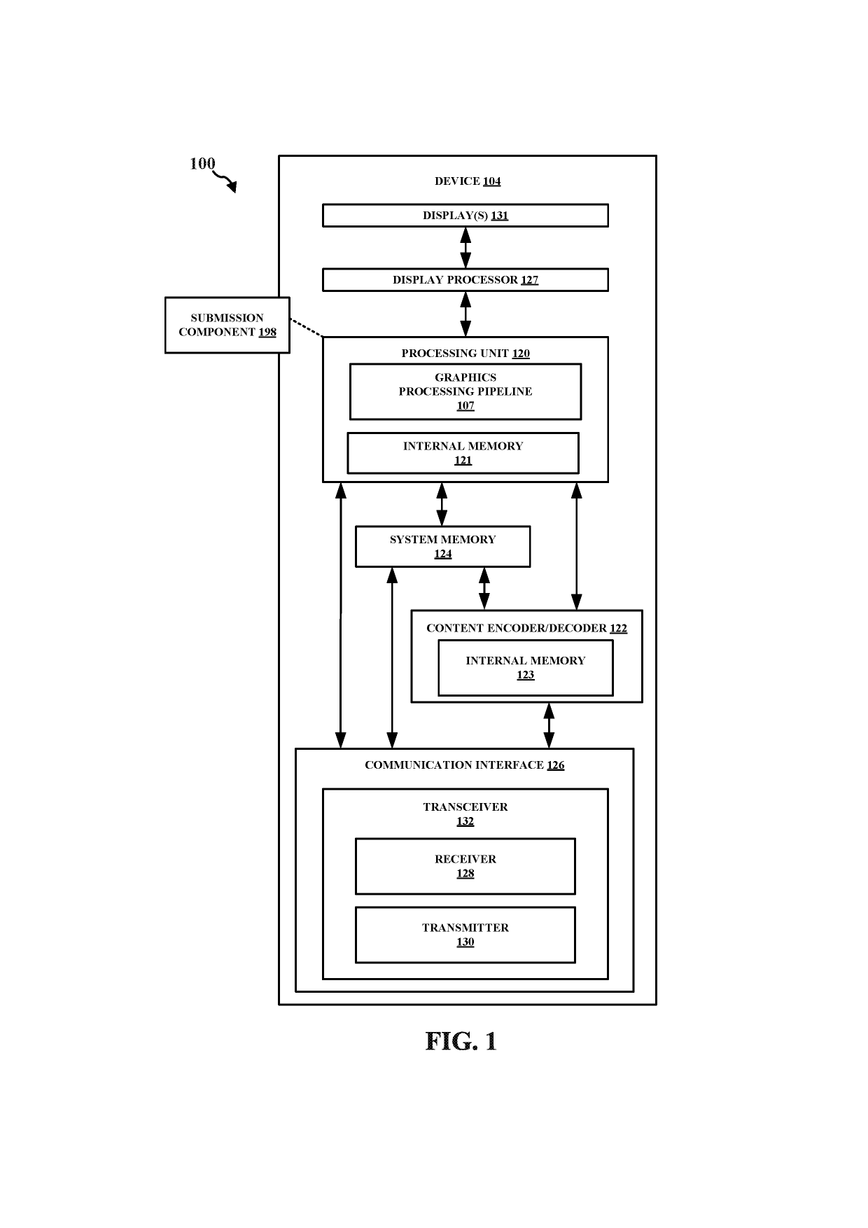

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 may include a number of components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this may be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 may include a communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a submission component 198 configured to receive, prior to monitoring a first set of graphics workloads, a set of application programming interface (API) calls associated with the first set of graphics workloads. The submission component 198 may also be configured to configure a set of register programs for each of the set of API calls associated with the first set of graphics workloads, where the set of register programs is to be executed at the graphics processor. The submission component 198 may also be configured to store, in a command buffer, the set of register programs for each of the set of API calls associated with the first set of graphics workloads. The submission component 198 may also be configured to output, to a graphics processor, a first indication of the first set of graphics workloads prior to monitoring the first set of graphics workloads. The submission component 198 may also be configured to monitor a first set of graphics workloads that were previously submitted to a graphics processor. The submission component 198 may also be configured to determine whether a status of each of the first set of graphics workloads is completed or executed at the graphics processor. The submission component 198 may also be configured to configure, based on the status of at least one graphics workload of the first set of graphics workloads being completed or executed at the graphics processor, a command for each of the second set of graphics workloads prior to outputting the command for each of the second set of graphics workloads. The submission component 198 may also be configured to output, based on the status of at least one graphics workload in the first set of graphics workloads being completed or executed at the graphics processor, an indication of a second set of graphics workloads to the graphics processor. The submission component 198 may also be configured to output, based on storage of the command for each of the second set of graphics workloads, a second indication of an address of the command buffer for each of the second set of graphics workloads. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, may be performed using other components (e.g., a CPU), consistent with disclosed embodiments.

GPUs may process multiple types of data or data packets in a GPU pipeline. For instance, in some aspects, a GPU may process two types of data or data packets, e.g., context register packets and draw call data. A context register packet may be a set of global state information, e.g., information regarding a global register, shading program, or constant data, which may regulate how a graphics context will be processed. For example, context register packets may include information regarding a color format. In some aspects of context register packets, there may be a bit that indicates which workload belongs to a context register. Also, there may be multiple functions or programming running at the same time and/or in parallel. For example, functions or programming may describe a certain operation, e.g., the color mode or color format. Accordingly, a context register may define multiple states of a GPU.

Context states may be utilized to determine how an individual processing unit functions, e.g., a vertex fetcher (VFD), a vertex shader (VS), a shader processor, or a geometry processor, and/or in what mode the processing unit functions. In order to do so, GPUs may use context registers and programming data. In some aspects, a GPU may generate a workload, e.g., a vertex or pixel workload, in the pipeline based on the context register definition of a mode or state. Certain processing units, e.g., a VFD, may use these states to determine certain functions, e.g., how a vertex is assembled. As these modes or states may change, GPUs may need to change the corresponding context. Additionally, the workload that corresponds to the mode or state may follow the changing mode or state.

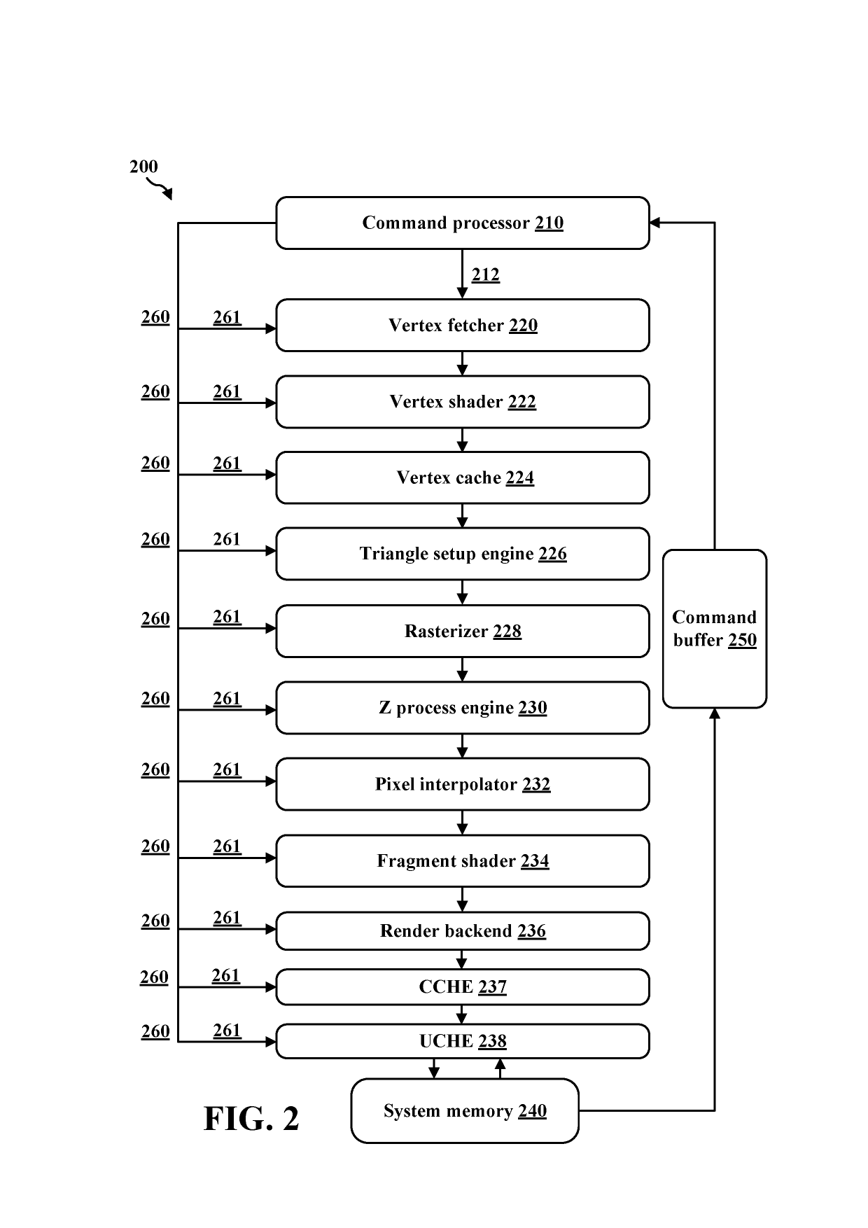

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 1 (L1) cache (cluster cache (CCHE)) 237, level 2 (L2) cache (UCHE) 238, and system memory 240. Although FIG. 2 displays that GPU 200 includes processing units 220-238, GPU 200 may include a number of additional processing units. Additionally, processing units 220-238 are merely an example and any combination or order of processing units may be used by GPUs according to the present disclosure. GPU 200 also includes command buffer 250, context register packets 260, and context states 261.

As shown in FIG. 2, a GPU may utilize a CP, e.g., CP 210, or hardware accelerator to parse a command buffer into context register packets, e.g., context register packets 260, and/or draw call data packets, e.g., draw call packets 212. The CP 210 may then send the context register packets 260 or draw call packets 212 through separate paths to the processing units or blocks in the GPU. Further, the command buffer 250 may alternate different states of context registers and draw calls. For example, a command buffer may be structured in the following manner: context register of context N, draw call(s) of context N, context register of context N+1, and draw call(s) of context N+1. GPUs may render images in a variety of different ways. In some instances, GPUs may render an image using rendering and/or tiled rendering. In tiled rendering GPUs, an image may be divided or separated into different sections or tiles. After the division of the image, each section or tile may be rendered separately. Tiled rendering GPUs may divide computer graphics images into a grid format, such that each portion of the grid, i.e., a tile, is separately rendered. In some aspects, during a binning pass, an image may be divided into different bins or tiles. In some aspects, during the binning pass, a visibility stream may be constructed where visible primitives or draw calls may be identified. In contrast to tiled rendering, direct rendering does not divide the frame into smaller bins or tiles. Rather, in direct rendering, the entire frame is rendered at a single time. Additionally, some types of GPUs may allow for both tiled rendering and direct rendering.

Instructions executed by a CPU (e.g., software instructions) or a display processor may cause the CPU or the display processor to search for and/or generate a composition strategy for composing a frame based on a dynamic priority and runtime statistics associated with one or more composition strategy groups. A frame to be displayed by a physical display device, such as a display panel, may include a plurality of layers. Also, composition of the frame may be based on combining the plurality of layers into the frame (e.g., based on a frame buffer). After the plurality of layers are combined into the frame, the frame may be provided to the display panel for display thereon. The process of combining each of the plurality of layers into the frame may be referred to as composition, frame composition, a composition procedure, a composition process, or the like.

A frame composition procedure or composition strategy may correspond to a technique for composing different layers of the plurality of layers into a single frame. The plurality of layers may be stored in double data rate (DDR) memory. Each layer of the plurality of layers may further correspond to a separate buffer. A composer or hardware composer (HWC) associated with a block or function may determine an input of each layer/buffer and perform the frame composition procedure to generate an output indicative of a composed frame. That is, the input may be the layers and the output may be a frame composition procedure for composing the frame to be displayed on the display panel.

Some types of GPUs may include different types of pipelines, such as a graphics processing pipeline. Graphics processing pipelines may include one or more of a vertex shader stage, a hull shader stage, a domain shader stage, a geometry shader stage, and a pixel shader stage. These stages of the graphics processing pipeline may be considered shader stages. These shader stages may be implemented as one or more shader programs that execute on shader units at a GPU. Shader units may be configured as a programmable pipeline of processing components. In some examples, a shader unit may be referred to as “shader processors” or “unified shaders,” and may perform geometry, vertex, pixel, or other shading operations to render graphics. Shader units may include shader processors, each of which may include one or more components for fetching and decoding operations, one or more arithmetic logic units (ALUs) for carrying out arithmetic calculations, one or more memories, caches, and registers.

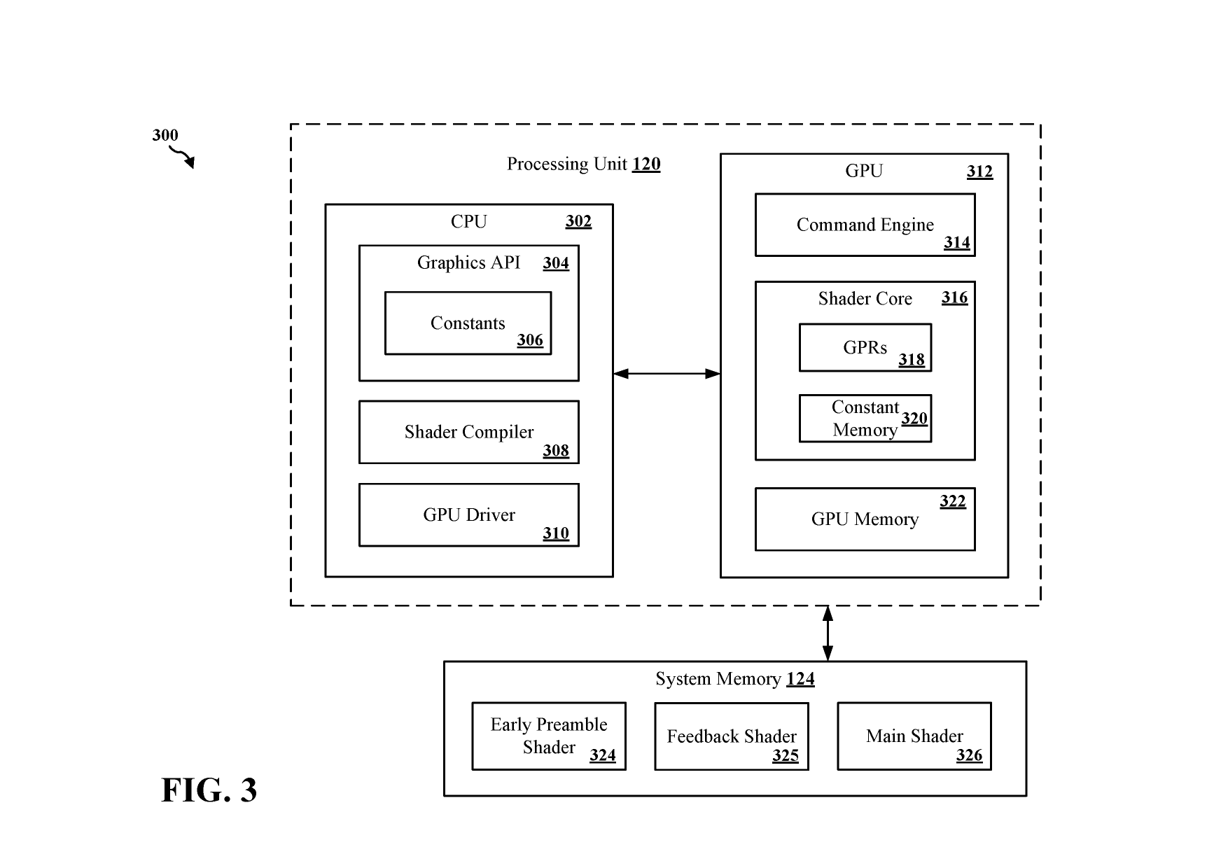

FIG. 3 is a diagram 300 that illustrates processing components, such as the processing unit 120 and the system memory 124, as may be identified in connection with the device 104 for processing data. In aspects, the processing unit 120 may include a CPU 302 and a GPU 312. The GPU 312 and the CPU 302 may be formed as an integrated circuit (e.g., a system-on-a-chip (SOC)) and/or the GPU 312 may be incorporated onto a motherboard with the CPU 302. Alternatively, the CPU 302 and the GPU 312 may be configured as distinct processing units that are communicatively coupled to each other. For example, the GPU 312 may be incorporated on a graphics card that is installed in a port of the motherboard that includes the CPU 302.

The CPU 302 may be configured to execute a software application that causes graphical content to be displayed (e.g., on the display(s) 131 of the device 104) based on one or more operations of the GPU 312. The software application may issue instructions to a graphics application program interface (API) 304, which may be a runtime program that translates instructions received from the software application into a format that is readable by a GPU driver 310. After receiving instructions from the software application via the graphics API 304, the GPU driver 310 may control an operation of the GPU 312 based on the instructions. For example, the GPU driver 310 may generate one or more command streams that are placed into the system memory 124, where the GPU 312 is instructed to execute the command streams (e.g., via one or more system calls). A command engine 314 included in the GPU 312 is configured to retrieve the one or more commands stored in the command streams. The command engine 314 may provide commands from the command stream for execution by the GPU 312. The command engine 314 may be hardware of the GPU 312, software/firmware executing on the GPU 312, or a combination thereof. While the GPU driver 310 is configured to implement the graphics API 304, the GPU driver 310 is not limited to being configured in accordance with any particular API. The system memory 124 may store the code for the GPU driver 310, which the CPU 302 may retrieve for execution. In examples, the GPU driver 310 may be configured to allow communication between the CPU 302 and the GPU 312, such as when the CPU 302 offloads graphics or non-graphics processing tasks to the GPU 312 via the GPU driver 310.

The system memory 124 may further store source code for one or more of an early preamble shader 324, a feedback shader 325, or a main shader 326. In such configurations, a shader compiler 308 executing on the CPU 302 may compile the source code of the shaders 324-326 to create object code or intermediate code executable by a shader core 316 of the GPU 312 during runtime (e.g., at the time when the shaders 324-326 are to be executed on the shader core 316). In some examples, the shader compiler 308 may pre-compile the shaders 324-326 and store the object code or intermediate code of the shader programs in the system memory 124. The shader compiler 308 (or in another example the GPU driver 310) executing on the CPU 302 may build a shader program with multiple components including the early preamble shader 324, the feedback shader 325, and the main shader 326. The main shader 326 may correspond to a portion or the entirety of the shader program that does not include the early preamble shader 324 or the feedback shader 325. The shader compiler 308 may receive instructions to compile the shader(s) 324-326 from a program executing on the CPU 302. The shader compiler 308 may also identify constant load instructions and common operations in the shader program for including the common operations within the early preamble shader 324 (rather than the main shader 326). The shader compiler 308 may identify such common instructions, for example, based on (presently undetermined) constants 306 to be included in the common instructions. The constants 306 may be defined within the graphics API 304 to be constant across an entire draw call. The shader compiler 308 may utilize instructions such as a preamble shader start to indicate a beginning of the early preamble shader 324 and a preamble shader end to indicate an end of the early preamble shader 324. Similar instructions may be used for the feedback shader 325 and the main shader 326. The feedback shader 325 will be described in further detail below.

The shader core 316 included in the GPU 312 may include general purpose registers (GPRs) 318 and constant memory 320. The GPRs 318 may correspond to a single GPR, a GPR file, and/or a GPR bank. Each GPR in the GPRs 318 may store data accessible to a single thread. The software and/or firmware executing on GPU 312 may be a shader program 324-326, which may execute on the shader core 316 of GPU 312. The shader core 316 may be configured to execute many instances of the same instructions of the same shader program in parallel. For example, the shader core 316 may execute the main shader 326 for each pixel that defines a given shape. The shader core 316 may transmit and receive data from applications executing on the CPU 302. In examples, constants 306 used for execution of the shaders 324-326 may be stored in a constant memory 320 (e.g., a read/write constant RAM) or the GPRs 318. The shader core 316 may load the constants 306 into the constant memory 320. In further examples, execution of the early preamble shader 324 or the feedback shader 325 may cause a constant value or a set of constant values to be stored in on-chip memory such as the constant memory 320 (e.g., constant RAM), the GPU memory 322, or the system memory 124. The constant memory 320 may include memory accessible by all aspects of the shader core 316 rather than just a particular portion reserved for a particular thread such as values held in the GPRs 318.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles.

In some aspects of graphics processing, GPU hardware may be divided into multiple sections, e.g., hardware for geometry processing and hardware for pixel processing. Scalable GPU hardware may be desirable in order to meet different throughputs across various market segments. Also, in some aspects, scalable hardware for pixel processing may be designed in a variety of ways. For instance, a screen may be divided into different parts and multiple pixel processing hardware modules (i.e., slices) may work independently on different parts of the screen. By changing the number of pixel slices, a scalable throughput may be achieved for different tiers. However, designing scalable geometry processing hardware has an inherent challenge of evenly distributing the workload across independently working hardware modules (i.e., geometry slices).

There are a number of issues that may be encountered when designing scalable geometry processing hardware. For instance, the variable size of a drawcall (i.e., a work unit) and an adaptive workload expansion in the middle of the geometry pipeline are some issues that may occur when designing scalable geometry processing hardware. Workloads across different drawcalls may vary, so tying each drawcall to a geometry slice may create uneven data downstream. Apart from this, an application program interface (API) may specify that a geometry pipeline may support adaptive workload expansion/reduction through different features, e.g., tessellation, geometry shading, and/or triangle culling.

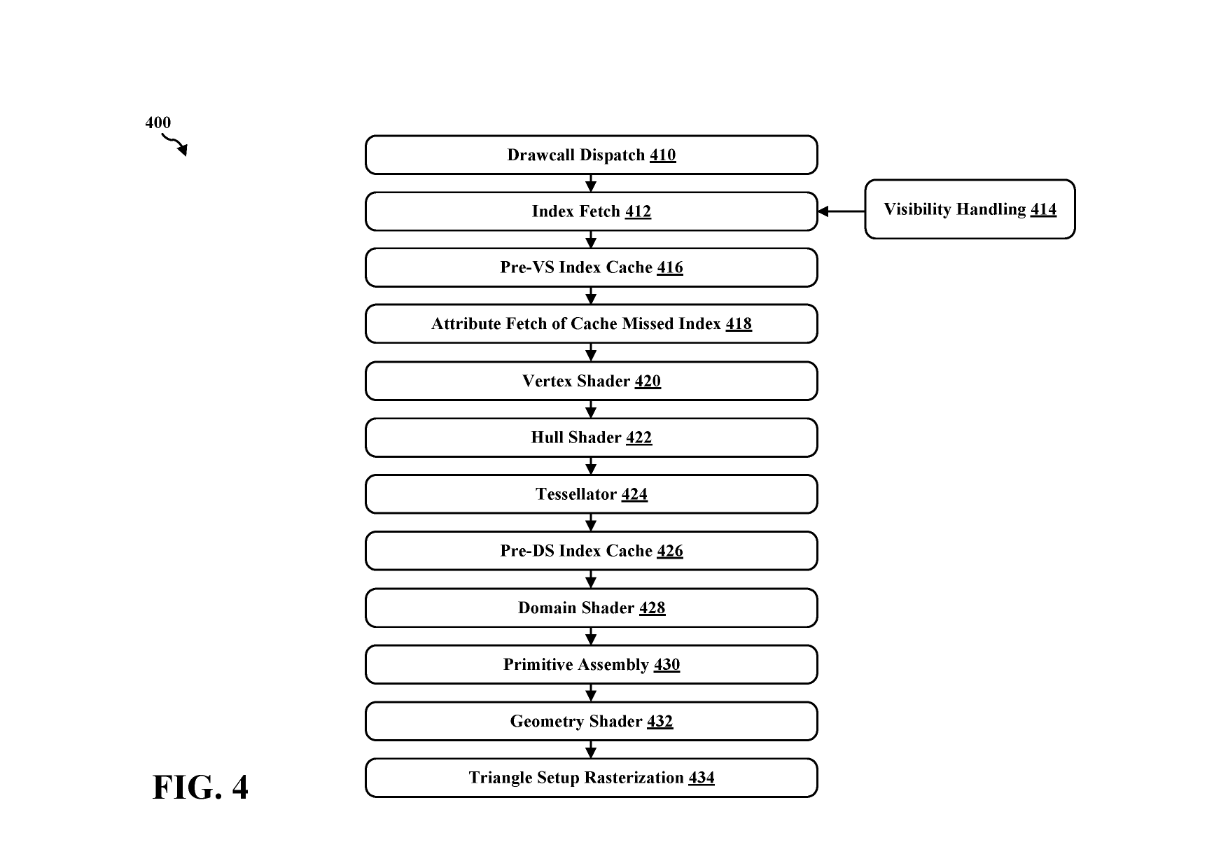

FIG. 4 is a diagram 400 illustrating an example geometry pipeline in a GPU. As depicted in FIG. 4, diagram 400 includes a drawcall dispatch 410, an index fetch 412, a visibility handling step 414, a pre-vertex shader index cache 416, an attribute fetch of a cache missed index 418, a vertex shader 420, a hull shader 422, a tessellator 424, a pre-domain shader index cache 426, a domain shader 428, a primitive assembly 430, a geometry shader 432, and a triangle setup rasterization 434. As shown in FIG. 4, after an index fetch 412, each primitive may be expanded to create multiple primitives, where an amplification factor may be determined during run-time. As such, sending primitives to different modules without considering an amplification factor may create an unequal workload in a downstream pipeline. Accordingly, this may prevent the achievement of an optimal throughput.

Another issue that may be encountered when designing scalable geometry processing hardware is visibility handling (e.g., tiled rendering) across multiple geometry slices. As indicated above, in tile-based rendering, the screen is divided into multiple bins, and a binning pass is used to generate a per-bin visibility stream (i.e., primitives that may be identified as visible in a bin). Also, the visibility stream may be used in multiple bin-rendering passes (e.g., dropping invisible primitives from processing) to render the whole screen. Because of different visibilities of primitives, the workload pattern in each bin-rendering pass may vary significantly from a binning pass. A workload distribution scheme may need to ensure that an even workload (including amplification) is distributed to each geometry slice (even when accounting for the potential disparity in visibility).

In some aspects, different types of GPU hardware may support different types of workload execution. Additionally, different types of workloads may take a different amount of processing time in various stages of the GPU pipeline. Also, these types of workloads may introduce inefficiency in GPU hardware utilization. In some aspects, scheduling algorithms in order to time-share the GPU hardware may sequence the workload to achieve the best utilization of GPU hardware. This kind of workload pattern is common in certain types of binning (e.g., concurrent binning). For example, in concurrent binning, a tile sorting pass for a certain frame (e.g., frame ‘N+1’) may be run concurrently with a rendering pass of another frame (e.g., frame ‘N’).

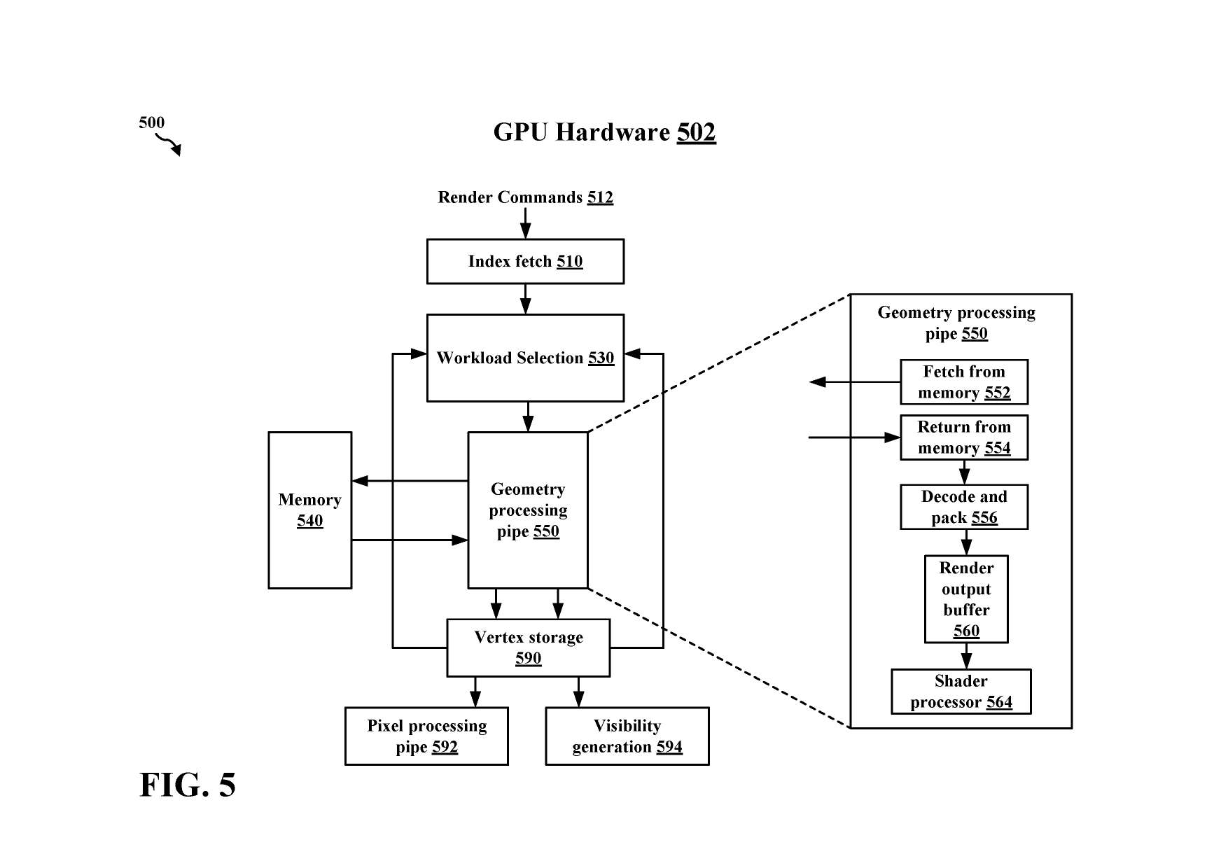

FIG. 5 illustrates diagram 500 including one example of GPU hardware. More specifically, diagram 500 depicts a time-shared GPU hardware for concurrent binning. As shown in FIG. 5, diagram 500 includes GPU hardware 502 including index fetch component 510, workload selection component 530, memory 540, geometry processing pipe 550, vertex storage component 590, pixel processing pipe 592, and visibility generation component 594. As shown in FIG. 5, render commands 512 may be input to index fetch component 510, which may be output to workload selection component 530. The workload selection component 530 may have a render/sort selection capability, as well as a certain granularity (e.g., a granularity for a group of N primitives). Also, the workload selection component 530 may be referred to as a workload selection switch component, switch component, workload selection component, or selection component. The “switch” may refers to a switch in the selection of render/sorting workloads. The output of workload selection component 530 may be sent to geometry processing pipe 550, which may communicate with memory 540. The geometry processing pipe 550 may include fetch from memory component 552, return from memory component 554, decode and pack component 556, render output buffer 560, and shader processor 564. Also, the output of geometry processing pipe 550 may be sent to vertex storage component 590, which may be sent to pixel processing pipe 592 and visibility generation component 594.

As shown in FIG. 5, geometry pipe hardware (e.g., geometry processing pipe 550) may be time shared between tile sorting and tile render workloads. Also, a scheduling algorithm (e.g., workload selection component 530) may consider the availability of GPU hardware for tile sorting and tile render workload. The granularity of a workload may be selected such that there is limited workload switching overhead. Further, the granularity of a workload may be selected such that, at the same time, one workload does not block the other. As shown in FIG. 5, the workload selection component 530 may have a granularity of a group of N primitives. For instance, for concurrent binning, the workload distribution granularity may be a primitive batch (e.g., a set of N primitives).

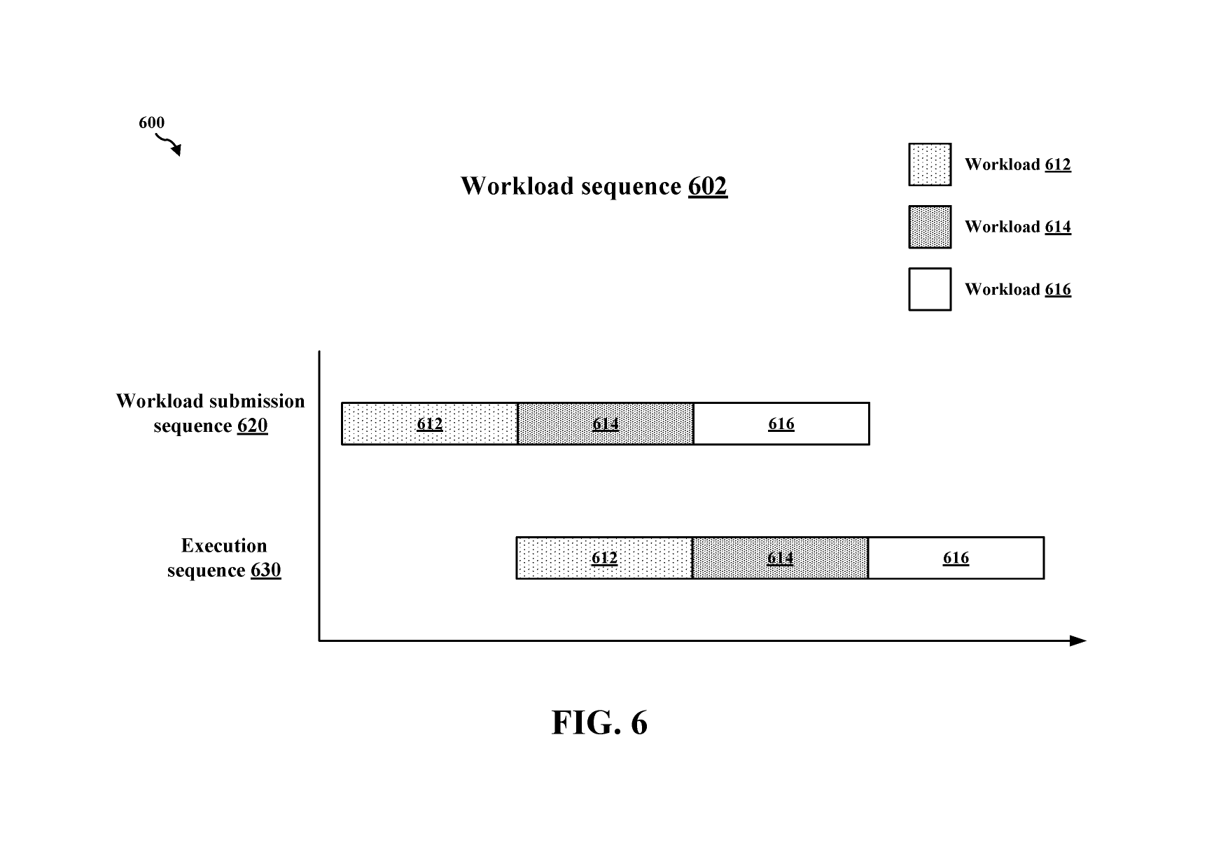

Certain types of workloads (e.g., sorting workloads) may face higher memory access latencies compared to other types of workloads (e.g., render workloads). For example, render workloads may be of higher priority than sorting workloads, which may face higher memory access latencies. In some aspects, if these types of workloads (e.g., sorting workloads) are executed in-order as per the scheduled workload sequence and granularity, there may be a reduction in hardware efficiency. For instance, if these types of workloads (e.g., sorting workloads) are executed in-order as per the scheduled workload sequence and granularity, a certain workload block (e.g., a head-of-line block) may occur, thus reducing the hardware efficiency. This type of scenario is shown in FIG. 6.

FIG. 6 illustrates diagram 600 including one example of a workload execution sequence. More specifically, diagram 600 depicts a workload execution sequence for a GPU (i.e., a scheduled execution order). As shown in FIG. 6, diagram 600 includes workload sequence 602 including workload 612, workload 614, workload 616, workload submission sequence 620, and execution sequence 630. FIG. 6 depicts a timeline of workload execution including workload submission sequence 620 and execution sequence 630. FIG. 6 illustrates that certain types of workloads (e.g., workload 612, workload 614, and workload 616) are executed in a certain order as per the scheduled workload sequence. As shown in FIG. 6, consider a workload submission sequence 620 (e.g., as determined by the workload selection component 530 in FIG. 5) to be workload 612, workload 614, and workload 616. Each of these workload may need to fetch data from memory (e.g., memory 540) and send it to shader processor (e.g., shader processor 564) for further processing. In some aspects, there may be a limit on how many requests can be made without processing the returned data (e.g., an OT limit). In some instances, some of the memory accesses for workload 614 may be granted before all accesses for workload 612, and some of the memory accesses for workload 616 may be granted before all accesses for workload 614.

In some applications or application programming interfaces (APIs) for graphics processing, a graphics workload submission can be controlled by a driver (e.g., a driver at a CPU, such as a graphics driver or a user mode driver (UMD)). The graphics workload submission may be scheduled based on a number of predefined conditions, such as a draw threshold (e.g., 1000 draws), memory space issues (e.g., video memory is out of space), etc. In these instances, the driver may have no option other than submitting the workload to the graphics processor or GPU. In the event that the driver submits a workload to the graphics processor or GPU, this may lead to inefficiencies, such as the suboptimal utilization of the graphics processor or GPU, as well as potential performance bottlenecks at the GPU or CPU.

In some cases, if the GPU has completed all submissions, it may remain idle until the graphics driver or user mode driver (UMD) (e.g., a driver at the CPU) sends the next submission. For example, if the driver submits a workload and the GPU completes this quickly, the driver may keep building the next workload. So during this period, some portion of the GPU may be pending idle because the workload is already completed and the GPU may be waiting for the next workload from the driver. So in these instances, the GPU will remain paused and not be fully utilized, which can lead to suboptimal GPU utilization. Indeed, if the graphics driver or UMD continues to accumulate workloads while the GPU is idle, parallelism may not be achieved between the CPU and GPU (i.e., when the CPU and GPU are working in a parallel and efficient manner). This may result in CPU-GPU serialization (i.e., the CPU and GPU working in-line with each other or working one at-a-time), which wastes time and resources at the CPU and GPU. Based on the above, it may be beneficial to optimize the efficiency between a CPU and a GPU. For instance, it may be beneficial to optimize the efficiency regarding graphics workloads between a CPU and a GPU. Also, it may be beneficial to achieve parallelism between the CPU and GPU (i.e., when a CPU and GPU are working in a parallel manner). Further, it may be beneficial to monitor idle working periods at a GPU in order to optimize the efficiency between a CPU and GPU.

Aspects of the present disclosure may optimize the efficiency between a CPU and a GPU. For instance, aspects presented herein may optimize the efficiency regarding graphics workloads between a CPU and a GPU. Additionally, aspects presented herein may achieve parallelism between the CPU and GPU (i.e., when a CPU and GPU are working in a parallel manner). Moreover, aspects presented herein may monitor idle working periods at a GPU in order to optimize the efficiency between a CPU and GPU. For instance, aspects presented herein may monitor graphics workloads that were previously submitted to a GPU and determine whether the graphics workloads are completed or executed at the GPU. By determining if the graphics workloads are completed or executed at the GPU, aspects presented herein may monitor the idle working periods at the GPU and increase the efficiency of the GPU and CPU. If the graphics workloads are completed or executed at the GPU and there is an idle working period at the GPU, aspects presented herein may transmit command or submission for a set of subsequent graphics workloads to the GPU.

In some instances, aspects presented herein may be performed by a driver (e.g., a driver at a CPU, such as a graphics driver or a user mode driver (UMD)). The driver may continuously monitor a status of workloads that were previously submitted. The driver (e.g., a graphics driver or UMD at a CPU) may keep track of completed graphics workloads and check the periods when the GPU is idle or not. Instead of relying solely on predefined conditions, the driver may evaluate the submitted workload’s status. During the idle periods, the driver may submit new workload to the GPU. As soon as the GPU becomes idle after completing a workload, the driver may schedule and submit the next workload. By adopting this, aspects presented herein may help to minimize the idle times at the GPU and improve the efficiency of the GPU. As workloads are more efficiently managed and executed, aspects presented herein may help lead to a higher GPU utilization and parallelism between the CPU and GPU (i.e., when a CPU and GPU are working in a parallel and efficient manner). This ensures that the GPU may remain consistently active, thus performing computations without unnecessary and inefficient downtime.

As mentioned herein, the driver (e.g., a graphics driver or UMD at a CPU) may evaluate a workload status for workloads that were previously submitted to a graphics processor or GPU. So the driver may check whether the earlier workloads (e.g., graphics workloads) are still being processed by the GPU or whether the earlier workloads are completed/executed by the GPU. Once the earlier workloads are completed/executed by the GPU, the driver may submit the new workloads to the GPU. The driver may also keep track of current or older workloads, so as to monitor idle periods at the GPU. Once these current or older workloads are processed by the GPU, the driver may immediately submit new workloads to the GPU, so that the GPU will not remain in an idle state. That is, once the GPU becomes idle, the driver may immediately submit new workloads to the GPU, so the GPU will always have some workloads to process. So as soon as the GPU becomes idle after completing a specific workload or earlier workloads, the driver may submit the next workload. By doing so, the GPU idle time is minimized, so the GPU utilization and efficiency may be improved. Also, the workloads may be more efficiently managed and executed, which will lead to a higher utilization at the GPU, which allows for a more efficient utilization of the GPU. This also results in parallelism of CPU and GPU (i.e., when a CPU and GPU are working in a parallel and efficient manner). And this ensures that the GPU may remain consistently active and perform computations without any idle periods.

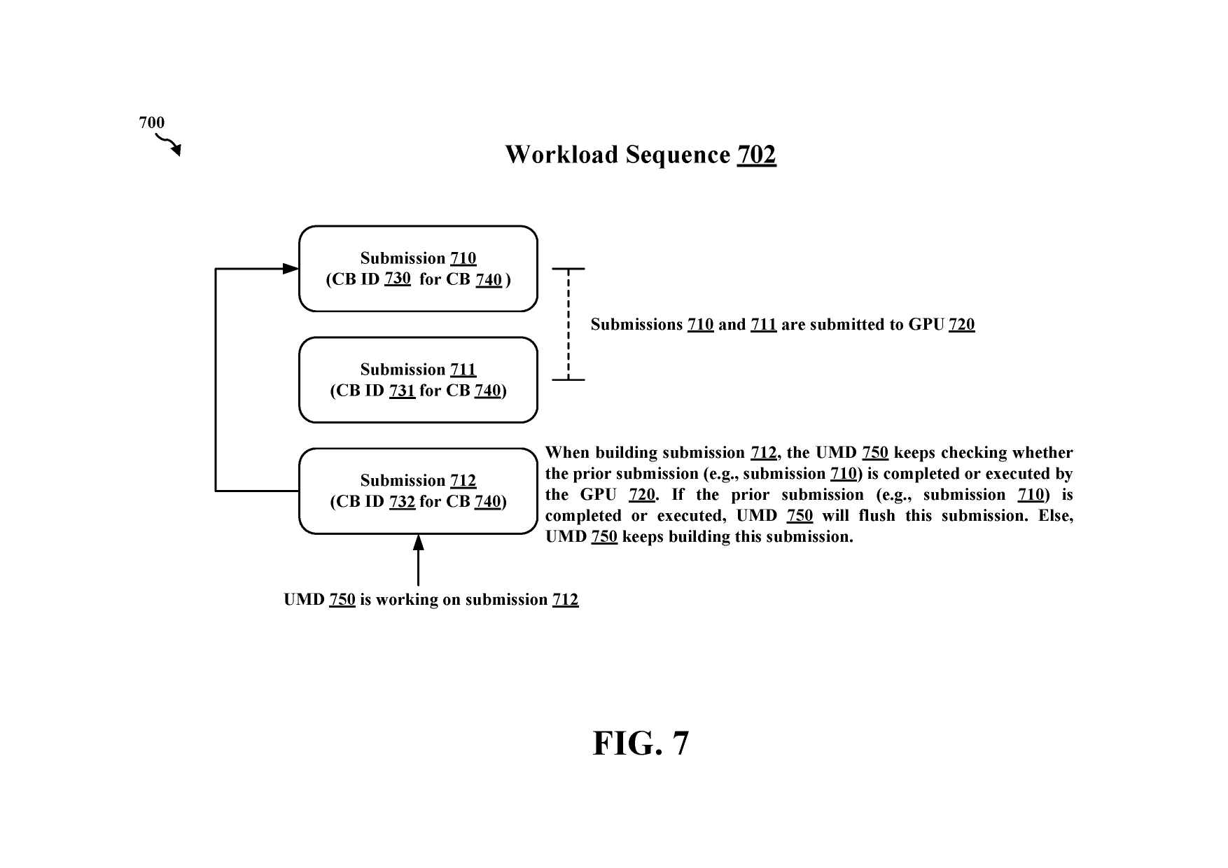

FIG. 7 illustrates diagram 700 including one example of a workload sequence. More specifically, diagram 700 depicts a workload sequence including a set of graphics workload submissions that are submitted to a graphics processor or GPU. As shown in FIG. 7, diagram 700 depicts workload sequence 702 including a set of workload submissions (e.g., submission 710, submission 711, and submission 712). FIG. 7 also references GPU 720, command buffer 740, and UMD 750. Further, as depicted in FIG. 7, submission 710, submission 711, and submission 712 are in workload sequence 702 and may be stored in a command buffer (CB) (e.g., command buffer 740). Each of the submissions may include a corresponding CB identifier (ID) for command buffer 740 (e.g., submission 710 includes CB ID 730, submission 711 includes CB ID 731, and submission 712 includes CB ID 732. Also, each of the submissions may be in an order to be stored in command buffer 740. For instance, submission 710 may be first in workload sequence 702 to be stored in command buffer 740, submission 711 may be second in workload sequence 702 to be stored in command buffer 740, and submission 712 may be third in workload sequence 702 to be stored in command buffer 740. That is, the CB ID for each submission may correspond to the order in workload sequence 702 that the submission is to be stored in command buffer 740.

Additionally, as shown in FIG. 7, submission 710 and submission 711 are previously submitted to GPU 720, while submission 712 is not yet submitted to GPU 720. For example, as depicted in FIG. 7, UMD 750 (e.g., a UMD, a driver, or a graphics driver at a CPU) may be currently working on a submission (e.g., submission 712), as this submission has not yet been submitted to GPU 720. When building a current submission (e.g., submission 712), the UMD 750 may keep determining (i.e., checking) whether a prior submission (e.g., submission 710) is completed or executed by GPU 720. If the prior submission (e.g., submission 710) is completed or executed by GPU 720, the UMD 750 may flush the current submission (e.g., submission 712). If the prior submission (e.g., submission 710) is not yet completed or executed by GPU 720, the UMD 750 may keep building the current submission (e.g., submission 712). The UMD 750 may monitor whether a prior submission (e.g., two submissions before a current submission) is completed or executed by GPU 720. For example, the UMD 750 may keep checking a fence of a prior workload submission (e.g., two workload submissions before a current workload submission) workload to determine whether it has been completed/executed by the GPU 720. A fence may refer to an instruction for a workload stating that each workload/command prior to the fence may need to be completed/executed before continuing to complete/execute any workloads/commands that are after the fence. Once the fence of a prior workload submission (e.g., two workload submissions before a current workload submission) is completed by the GPU 720, the UMD 750 can submit the next workload.

As shown in FIG. 7, there are two submissions (e.g., submission 710 and submission 711) which have been completed by the UMD 750 (e.g., a UMD, a driver, or a graphics driver at a CPU). The GPU 720 may still be processing these two submissions and the UMD 750 (e.g., a UMD, driver, or a graphics driver at a CPU) may be working on another submission (e.g., submission 712). The UMD 750 may keep track off the earlier two submissions (e.g., submission 710 and submission 711). So while working on a current submission (e.g., submission 712), the UMD 750 may keep track of the earlier two submissions (e.g., submission 710 and submission 711). That is, the UMD 750, when building/working on a submission (e.g., submission 712), it keeps checking on previous submissions (e.g., the previous two submissions) that are prior to the current submission (e.g., submission 712). For example, the UMD 750 may keep checking whether a prior submission (e.g., submission 710 and submission 711) is completed by the GPU 720 or if it is still being processed. Once the particular submission is completed/executed by the GPU 720, the UMD 750 (e.g., a UMD, a driver, or a graphics driver at a CPU) may stop processing the submission and submit to the GPU 720 whatever has been accumulated so far. And then the UMD 750 may start processing/working on the next submission.

As depicted in FIG. 7, the UMD 750 (e.g., a UMD, a driver, or a graphics driver at a CPU) may keep track of one or more previous submissions (e.g., the prior two submissions) because whenever the UMD 750 decides to submit a workload submission, there may be some amount of submit overload/overhead. This submit overload/overhead occurs because the UMD 750 or driver has a certain amount of time to create an amount of command buffer packets, and then the UMD 750 or driver may have some more tasks to add/submit. That is, the amount of command buffer packets and tasks may cause an overhead at the UMD 750 or driver, so if the UMD 750 or driver tracks a particular submission once this is complete, then if the UMD 750 or driver decides to do a submission, there may be a delay. And during that particular delay, the GPU 720 may remain idle. Accordingly, if the UMD 750 or driver tracks one or more previous submissions (e.g., the prior two submissions), this may reduce or eliminate any idle periods at the GPU 720. Indeed, once a current submission is done, the GPU 720 may start processing this submission and the UMD 750 or driver can start a creating a corresponding command buffer packet and perform a submission, so that GPU will also remain busy and the UMD 750 or driver can submit this particular submission and start working on next submission. So if the UMD 750 or driver monitor one or more previous submissions (e.g., the prior two submissions), the GPU 720 may remain active and there may not be any idle periods at the CPU or GPU. As such, by tracking one or more previous submissions (e.g., the prior two submissions), parallelism may be achieved between the CPU and GPU (i.e., the CPU and GPU are working in a parallel manner).

As illustrated in FIG. 7, the UMD 750 (e.g., a UMD, a driver, or a graphics driver at a CPU) may have the flexibility to monitor/check the status of a prior workload submission (e.g., a second-to-last prior submission). That is, the UMD/driver may monitor the status of a prior workload submission in accordance with several targets or boundaries. For instance, the UMD/driver may monitor the status of a prior workload submission in accordance with a render target (RT) boundary. Also, the UMD/driver may monitor the status of a prior workload submission in accordance with a draw/dispatch boundary. Moreover, the UMD/driver may monitor the status of a prior workload submission in accordance with a resource operations boundary. These types of boundaries may be needed for each time the UMD/driver checks a prior submission (i.e., to determine whether the UMD/driver can actually check whether a certain submission (e.g., second-to-last submission) is executed or not). So these are the options in which the UMD/driver can check whether a certain submission (e.g., second-to-last submission) is executed or not (e.g., check each render target, each draw/dispatch, or each resource operation). For instance, whenever the UMD/driver decides to change the render target, draw, resource operation (e.g., a copy operation or a clear operation) on those boundaries, the UMD/driver can check on the status of a certain prior submission (e.g., second-to-last submission). So there are the different granularities when the UMD/driver can check on the status of a certain prior submission (e.g., second-to-last submission). Additionally, one of the reasons for the UMD/driver to monitor/check a prior workload submission (e.g., a second-to-last prior submission or two submissions prior to a current submission) is to reduce/eliminate idle periods at the GPU (e.g., idle periods at the GPU due to a flush overhead at the CPU). Therefore, by tracking one or more previous submissions (e.g., the two submissions prior to a current submission), the CPU and GPU may achieve parallelism (i.e., the CPU and GPU are working in a parallel manner).

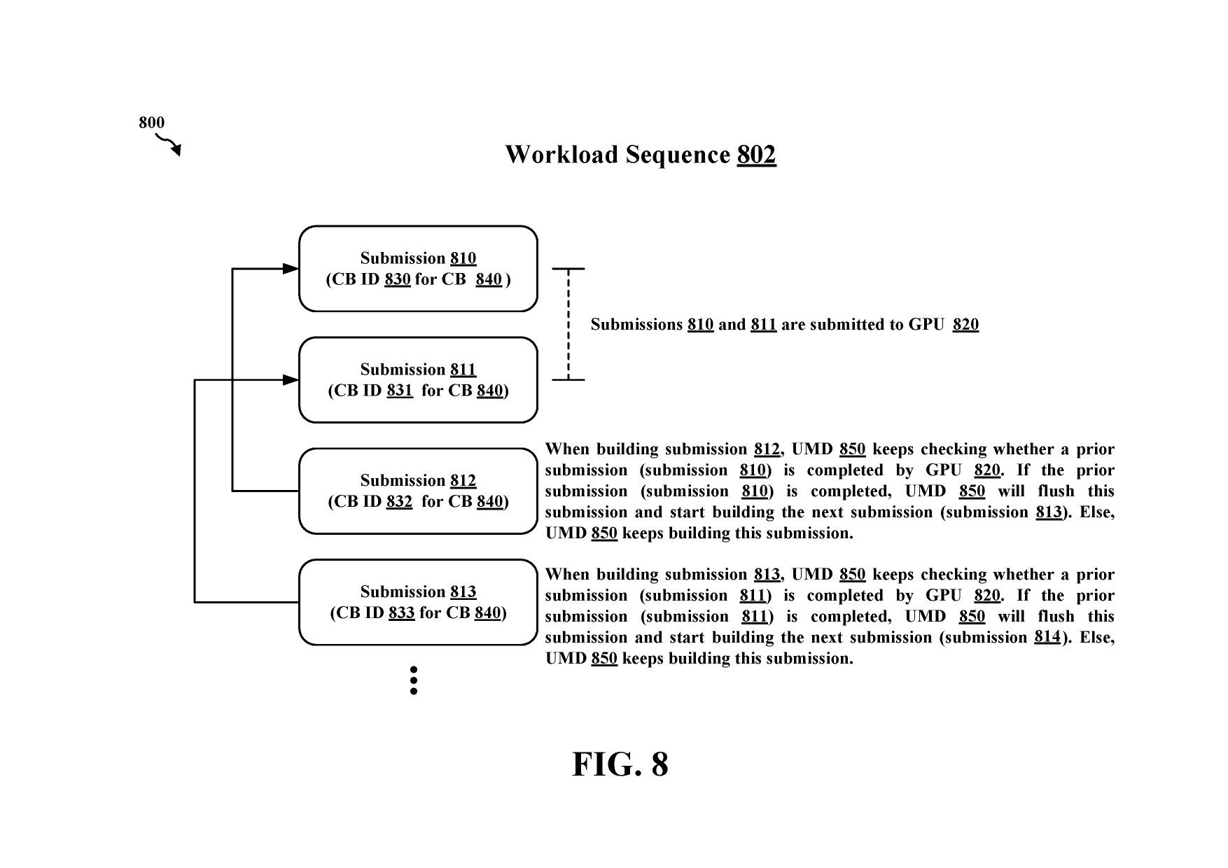

FIG. 8 illustrates diagram 800 including one example of a workload sequence. More specifically, diagram 800 depicts a workload sequence including a set of graphics workload submissions that are submitted to a graphics processor or GPU. As shown in FIG. 8, diagram 800 depicts workload sequence 802 including a set of workload submissions (e.g., submission 810, submission 811, submission 812, and submission 813). FIG. 8 also references GPU 820, command buffer 840, and UMD 850. Moreover, as depicted in FIG. 8, submission 810, submission 811, submission 812, and submission 813 are in workload sequence 802 and may be stored in a command buffer (CB) (e.g., command buffer 840). Each of the submissions may include a corresponding CB identifier (ID) for command buffer 840 (e.g., submission 810 includes CB ID 830, submission 811 includes CB ID 831, submission 812 includes CB ID 832, and submission 813 includes CB ID 833. In addition, each of the submissions may be in an order to be stored in command buffer 840. For example, submission 810 may be first in workload sequence 802 to be stored in command buffer 840, submission 811 may be second in workload sequence 802 to be stored in command buffer 840, submission 812 may be third in workload sequence 802 to be stored in command buffer 840, and submission 813 may be fourth in workload sequence 802 to be stored in command buffer 840. So the CB ID for each submission may correspond to the order in workload sequence 802 that the submission is to be stored in command buffer 840.

Additionally, as shown in FIG. 8, submission 810 and submission 811 are previously submitted to GPU 820, while submission 812 and submission 813 are not yet submitted to GPU 820. For example, as depicted in FIG. 8, UMD 850 (e.g., a UMD, a driver, or a graphics driver at a CPU) may be currently working on a submission (e.g., submission 812 or submission 813), as this submission has not yet been submitted to GPU 820. As shown in FIG. 8, when building a current submission (e.g., submission 812), the UMD 850 may keep determining (i.e., checking) whether a prior submission (e.g., submission 810) is completed or executed by GPU 820. If the prior submission (e.g., submission 810) is completed or executed by GPU 820, the UMD 850 may flush the current submission (e.g., submission 812) and start building the next submission (e.g., submission 813). If the prior submission (e.g., submission 810) is not yet completed or executed by GPU 820, the UMD 850 may keep building the current submission (e.g., submission 812). Additionally, as shown in FIG. 8, for another submission, when building a current submission (e.g., submission 813), the UMD 850 may keep determining (i.e., checking) whether a prior submission (e.g., submission 811) is completed or executed by GPU 820. If the prior submission (e.g., submission 811) is completed or executed by GPU 820, the UMD 850 may flush the current submission (e.g., submission 813) and start building the next submission (e.g., submission 814). If the prior submission (e.g., submission 811) is not yet completed or executed by GPU 820, the UMD 850 may keep building the current submission (e.g., submission 813).

As illustrated in FIG. 8, the UMD 850 may monitor whether a prior submission (e.g., two submissions before a current submission) is completed or executed by GPU 820. This process may occur for multiple submissions in the workload sequence 802. For instance, when building submission 812, the UMD 850 may determine whether a prior submission (e.g., submission 810) is completed or executed by GPU 820. Also, when building submission 813, the UMD 850 may determine whether a prior submission (e.g., submission 811) is completed or executed by GPU 820. In some instances, the UMD 850 may keep checking a fence of a prior workload submission (e.g., two workload submissions before a current workload submission) workload to determine whether it has been completed/executed by the GPU 820. As indicated herein, a fence may refer to an instruction for a workload stating that each workload/command prior to the fence may need to be completed/executed before continuing to complete/execute any workloads/commands that are after the fence. Once the fence of a prior workload submission (e.g., two workload submissions before a current workload submission) is completed by the GPU 820, the UMD 850 can submit the next workload.

As shown in FIG. 8, there are two submissions (e.g., submission 810 and submission 811) which have been completed by the UMD 850 (e.g., a UMD, a driver, or a graphics driver at a CPU). The GPU 820 may still be processing these two submissions and the UMD 850 (e.g., a UMD, driver, or a graphics driver at a CPU) may be working on other submissions (e.g., submission 812 and/or submission 813). The UMD 850 may keep track off the earlier two submissions (e.g., submission 810 and submission 811). So while working on a current submission (e.g., submission 812 and/or submission 813), the UMD 850 may keep track of the earlier two submissions (e.g., submission 810 and submission 811). That is, when the UMD 850 is building/working on a submission (e.g., submission 812 or submission 813), it may keep checking on previous submissions (e.g., submission 810 or submission 811) that are prior to the current submission (e.g., submission 812 or submission 813). For example, when building/working on a submission 812, the UMD 850 may check whether a prior submission (e.g., submission 810) is completed by the GPU 820 or if it is still being processed. Also, when building/working on a submission 813, the UMD 850 may check whether a prior submission (e.g., submission 811) is completed by the GPU 820 or if it is still being processed. Once the particular submission (e.g., submission 811) is completed/executed by the GPU 820, the UMD 850 (e.g., a UMD, a driver, or a graphics driver at a CPU) may stop processing the current submission (e.g., submission 813) and submit to the GPU 820 whatever has been accumulated so far. Then the UMD 850 may start processing/working on the next submission (e.g., submission 814).

Additionally, in some instances, the UMD 850 (e.g., a UMD, a driver, or a graphics driver at a CPU) may keep track of one or more previous submissions (e.g., the prior two submissions) because whenever the UMD 850 decides to submit a workload submission, there may be some amount of submit overload/overhead. This submit overload/overhead occurs because the UMD 850 or driver has a certain amount of time to create an amount of command buffer packets, and then the UMD 850 or driver may have some more tasks to add/submit. So the amount of command buffer packets and tasks may cause an overhead at the UMD 850 or driver, so if the UMD 850 or driver tracks a particular submission once this is complete, then if the UMD 850 or driver decides to do a submission, there may be a delay. During that particular delay, the GPU 820 may remain idle. As such, if the UMD 850 or driver tracks one or more previous submissions (e.g., the prior two submissions), this may reduce or eliminate any idle periods at the GPU 820. That is, once a current submission is done, the GPU 820 may start processing this submission and the UMD 850 or driver can start a creating a corresponding command buffer packet and perform a submission, so that GPU will also remain busy and the UMD 850 or driver can submit this particular submission and start working on next submission. Thus, if the UMD 850 or driver monitor one or more previous submissions (e.g., the prior two submissions), the GPU 820 may remain active and there may not be any idle periods at the CPU or GPU. Accordingly, by tracking one or more previous submissions (e.g., the prior two submissions), parallelism may be achieved between the CPU and GPU (i.e., the CPU and GPU are working in a parallel manner).

In some applications or application programming interfaces (APIs) for graphics processing, a UMD or driver at a CPU may submit workloads to a GPU based on a number of circumstances. For instance, a UMD or driver at a CPU may submit workloads to a GPU based on static heuristics. Also, a UMD or driver at a CPU may submit workloads to a GPU when accumulated draws are more than a threshold. Further, a UMD or driver at a CPU may submit workloads to a GPU when there is out of space for allocations. In contrast, aspects presented herein may utilize dynamic GPU workload submission by monitoring/checking previous workload submissions. This dynamic GPU workload submission may help to considerably increase the parallelism between a CPU and GPU (i.e., when the CPU and GPU are working in a parallel and efficient manner). By doing so, aspects presented herein may help to avoid serialization between a CPU and GPU (i.e., the CPU and GPU working in-line with each other or working one at-a-time), which wastes time and resources at the CPU and GPU.

Aspects of the present disclosure may include a number of benefits or advantages. For instance, aspects presented herein may optimize the efficiency regarding graphics workloads between a CPU and a GPU. Additionally, aspects presented herein may achieve parallelism between the CPU and GPU (i.e., when a CPU and GPU are working in a parallel manner). Moreover, aspects presented herein may monitor idle working periods at a GPU in order to optimize the efficiency between a CPU and GPU. For instance, aspects presented herein may monitor graphics workloads that were previously submitted to a GPU and determine whether the graphics workloads are completed or executed at the GPU. By determining if the graphics workloads are completed or executed at the GPU, aspects presented herein may monitor the idle working periods at the GPU and increase the efficiency of the GPU and CPU. By doing so, aspects presented herein may help to increase the parallelism between a CPU and GPU (i.e., when the CPU and GPU are working in a parallel and efficient manner). Thus, aspects presented herein may help to keep the GPU active and avoid performance bottlenecks. Aspects presented herein may also improve the performance/speed of a GPU because the utilization of the GPU will be increased.

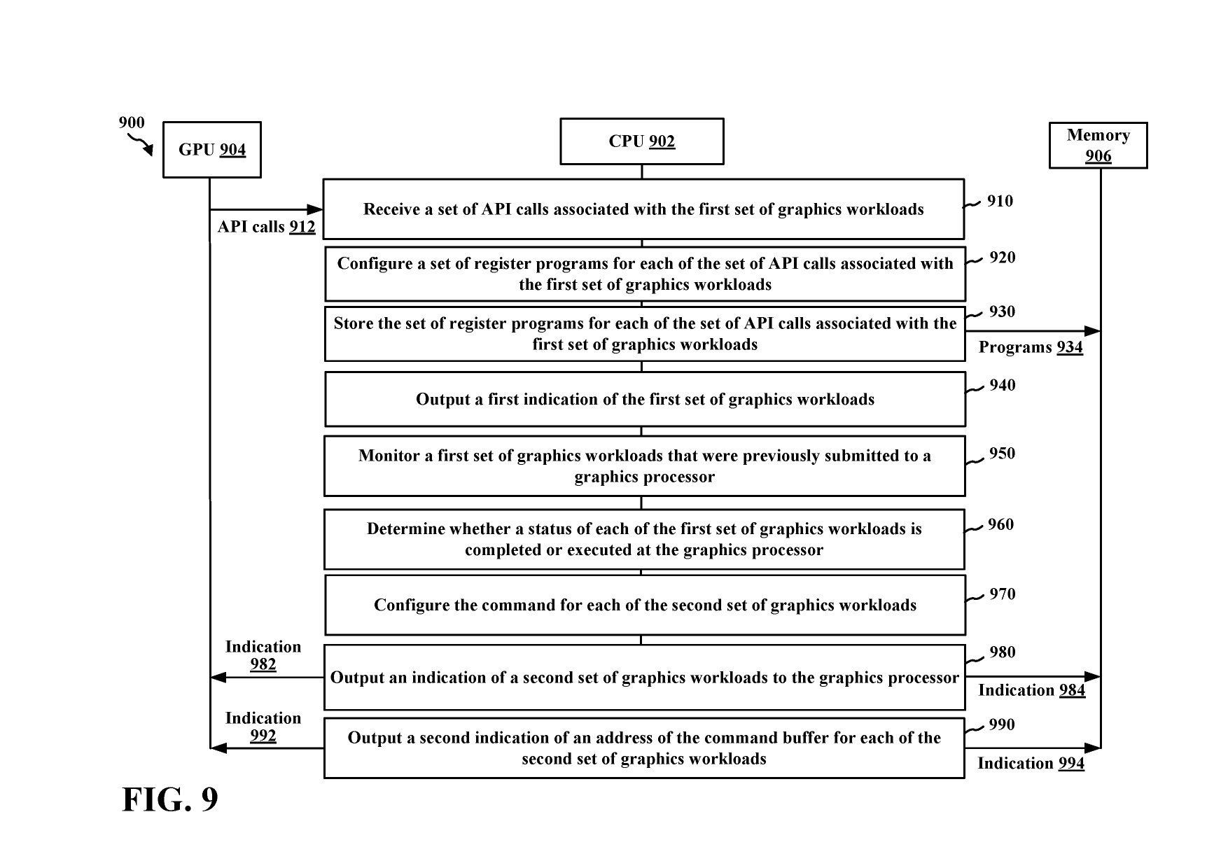

FIG. 9 is a communication flow diagram 900 of graphics processing in accordance with one or more techniques of this disclosure. As shown in FIG. 9, diagram 900 includes example communications between CPU 902 (e.g., a CPU, a CPU component, or another central processor, a GPU, a cache at a GPU, a GPU component, or another graphics processor), GPU 904 (e.g., a GPU, a cache at a GPU, a GPU component, another graphics processor, a CPU, a CPU component, or another central processor), and memory 906 (e.g., a memory, a cache, a system memory, a graphics memory, a memory or cache at a CPU, or a memory or cache at a GPU), in accordance with one or more techniques of this disclosure.

At 910, CPU 902 may receive, prior to monitoring a first set of graphics workloads, a set of application programming interface (API) calls associated with the first set of graphics workloads. For example, CPU 902 may receive API calls 912 from GPU 904.

At 920, CPU 902 may configure a set of register programs for each of the set of API calls associated with the first set of graphics workloads, where the set of register programs is to be executed at the graphics processor.

At 930, CPU 902 may store, in a command buffer, the set of register programs for each of the set of API calls associated with the first set of graphics workloads. For example, CPU 902 may store register programs 934 in memory 906.

At 940, CPU 902 may output, to a graphics processor, a first indication of the first set of graphics workloads prior to monitoring the first set of graphics workloads. In some aspects, outputting the first indication of the first set of graphics workloads may comprise: outputting a command for each of the first set of graphics workloads. Also, outputting the command for each of the first set of graphics workloads may comprise: storing, in a command buffer, the command for each of the first set of graphics workloads based on a set of predefined conditions.

At 950, CPU 902 may monitor a first set of graphics workloads that were previously submitted to a graphics processor.

At 960, CPU 902 may determine whether a status of each of the first set of graphics workloads is completed or executed at the graphics processor. In some aspects, the status of each of the first set of graphics workloads may be at least one of: a fence for each of the first set of graphics workloads or a timestamp for each of the first set of graphics workloads. Also, the determination of the status of each of the first set of graphics workloads may be based on at least one of: a render target (RT) boundary, a draw boundary, a dispatch boundary, or a resource operations boundary. Further, the determination of the status of each of the first set of graphics workloads may be associated with an application programming interface (API) call for the second set of graphics workloads.

At 970, CPU 902 may configure, based on the status of at least one graphics workload of the first set of graphics workloads being completed or executed at the graphics processor, a command for each of the second set of graphics workloads prior to outputting the command for each of the second set of graphics workloads. In some aspects, configuring the command for each of the second set of graphics workloads may comprise: generating a command buffer packet for each of the second set of graphics workloads.

At 980, CPU 902 may output, based on the status of at least one graphics workload in the first set of graphics workloads being completed or executed at the graphics processor, an indication of a second set of graphics workloads to the graphics processor. In some aspects, outputting the indication of the second set of graphics workloads may comprise: outputting a command for each of the second set of graphics workloads. Also, outputting the command for each of the first set of graphics workloads may comprise: storing, in a command buffer, the command for each of the second set of graphics workloads. For example, CPU 902 may store indication 984 in memory 906. Moreover, outputting the indication of the second set of graphics workloads may comprise: transmitting a submission of the second set of graphics workloads to the graphics processor. For example, CPU 902 may transmit indication 982 to GPU 904. In some instances, the first set of graphics workloads may comprise a first graphics workload and a second graphics workload. Also, the first graphics workload and the second graphics workload may be submitted to the graphics processor prior to the second set of graphics workloads. The second set of graphics workloads may be subsequent to the first set of graphics workloads in a workload order at the graphics processor. Additionally, the at least one graphics workload may comprise a first graphics workload and a second graphics workload that were previously submitted to the graphics processor.

At 990, CPU 902 may output, based on storage of the command for each of the second set of graphics workloads, a second indication of an address of the command buffer for each of the second set of graphics workloads. In some aspects, outputting the second indication of the address of the command buffer for each of the second set of graphics workloads may comprise: transmitting, to the graphics processor, the second indication of the address of the command buffer for each of the second set of graphics workloads. For example, CPU 902 may transmit indication 992 to GPU 904. Also, for example, CPU 902 may store indication 994 in memory 906.

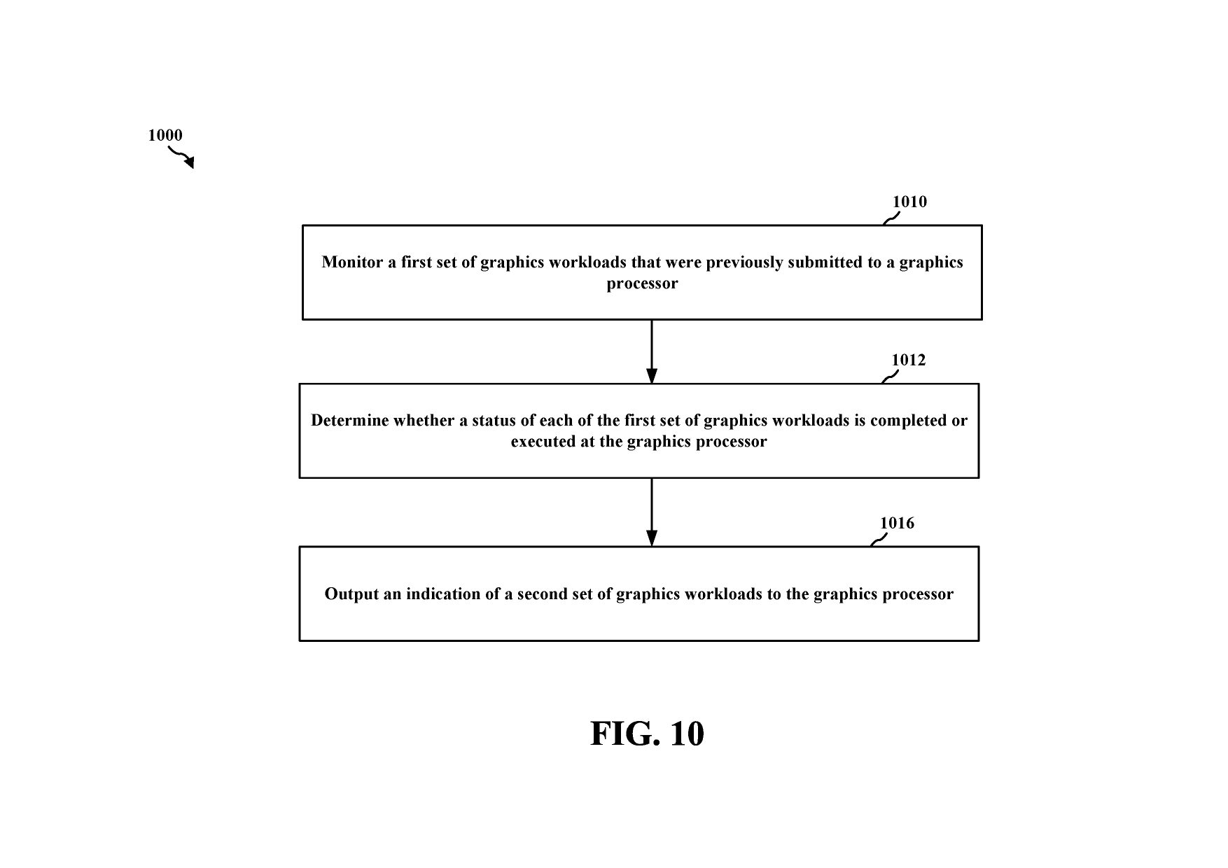

FIG. 10 is a flowchart 1000 of an example method of graphics processing in accordance with one or more techniques of this disclosure. The method may be performed by a CPU (e.g., a CPU, a cache at a CPU, a CPU component, another central processor, a GPU, a GPU component, or another graphics processor), a GPU (e.g., a GPU, a cache at a GPU, a GPU component, another graphics processor, a CPU, a CPU component, or another central processor), a display driver integrated circuit (DDIC), an apparatus for graphics processing, a wireless communication device, and/or any apparatus that may perform graphics processing as used in connection with the examples of FIGS. 1-9.

At 1010, the CPU may monitor a first set of graphics workloads that were previously submitted to a graphics processor, as described in connection with the examples in FIGS. 1-9. For example, as described in 950 of FIG. 9, CPU 902 may monitor a first set of graphics workloads that were previously submitted to a graphics processor. Further, step 1010 may be performed by processing unit 120 in FIG. 1.

At 1012, the CPU may determine whether a status of each of the first set of graphics workloads is completed or executed at the graphics processor, as described in connection with the examples in FIGS. 1-9. For example, as described in 960 of FIG. 9, CPU 902 may determine whether a status of each of the first set of graphics workloads is completed or executed at the graphics processor. Further, step 1012 may be performed by processing unit 120 in FIG. 1. In some aspects, the status of each of the first set of graphics workloads may be at least one of: a fence for each of the first set of graphics workloads or a timestamp for each of the first set of graphics workloads. Also, the determination of the status of each of the first set of graphics workloads may be based on at least one of: a render target (RT) boundary, a draw boundary, a dispatch boundary, or a resource operations boundary. Further, the determination of the status of each of the first set of graphics workloads may be associated with an application programming interface (API) call for the second set of graphics workloads.

At 1016, the CPU may output, based on the status of at least one graphics workload in the first set of graphics workloads being completed or executed at the graphics processor, an indication of a second set of graphics workloads to the graphics processor, as described in connection with the examples in FIGS. 1-9. For example, as described in 980 of FIG. 9, CPU 902 may output, based on the status of at least one graphics workload in the first set of graphics workloads being completed or executed at the graphics processor, an indication of a second set of graphics workloads to the graphics processor. Further, step 1016 may be performed by processing unit 120 in FIG. 1. In some aspects, outputting the indication of the second set of graphics workloads may comprise: outputting a command for each of the second set of graphics workloads. Also, outputting the command for each of the first set of graphics workloads may comprise: storing, in a command buffer, the command for each of the second set of graphics workloads. Moreover, outputting the indication of the second set of graphics workloads may comprise: transmitting a submission of the second set of graphics workloads to the graphics processor. In some instances, the first set of graphics workloads may comprise a first graphics workload and a second graphics workload. Also, the first graphics workload and the second graphics workload may be submitted to the graphics processor prior to the second set of graphics workloads. The second set of graphics workloads may be subsequent to the first set of graphics workloads in a workload order at the graphics processor. Additionally, the at least one graphics workload may comprise a first graphics workload and a second graphics workload that were previously submitted to the graphics processor.

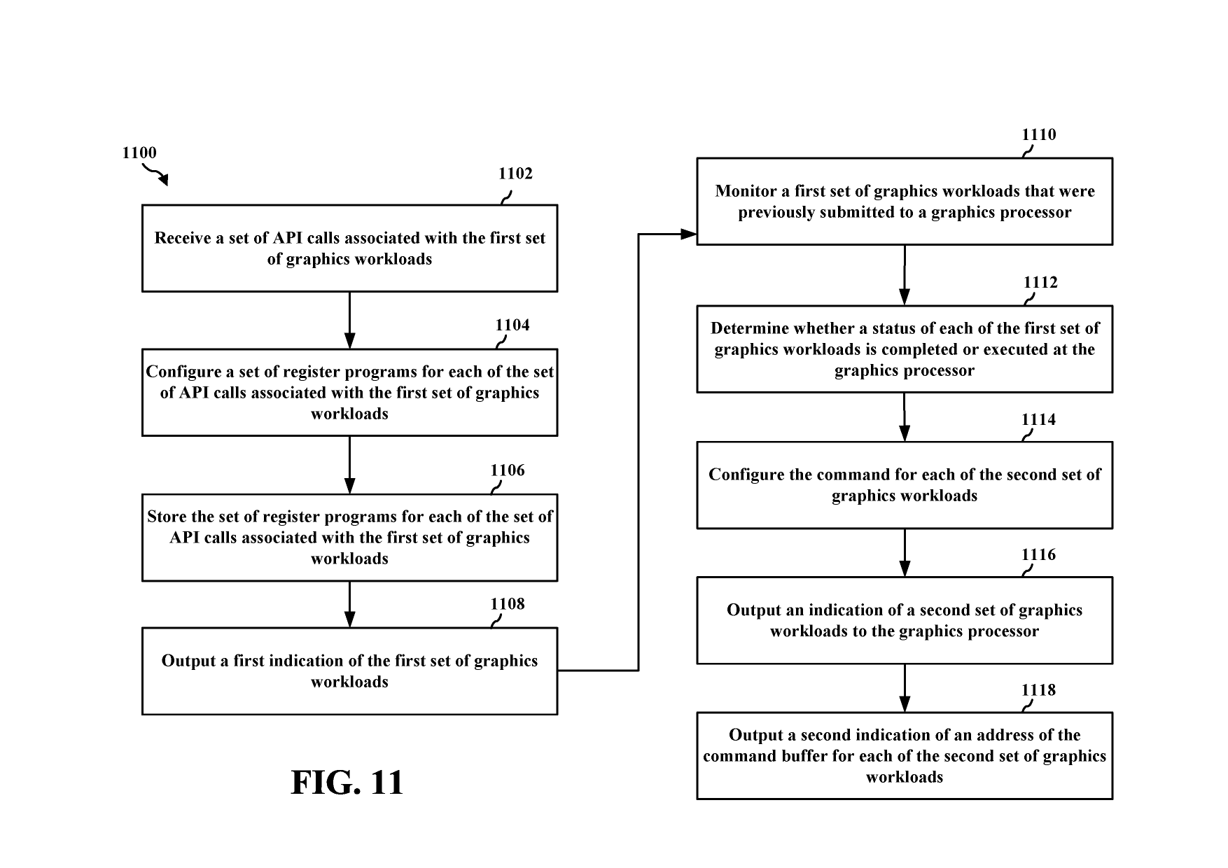

FIG. 11 is a flowchart 1100 of an example method of graphics processing in accordance with one or more techniques of this disclosure. The method may be performed by a CPU (e.g., a CPU, a cache at a CPU, a CPU component, another central processor, a GPU, a GPU component, or another graphics processor), a GPU (e.g., a GPU, a cache at a GPU, a GPU component, another graphics processor, a CPU, a CPU component, or another central processor), a display driver integrated circuit (DDIC), an apparatus for graphics processing, a wireless communication device, and/or any apparatus that may perform graphics processing as used in connection with the examples of FIGS. 1-9.

At 1102, the CPU may receive, prior to monitoring a first set of graphics workloads, a set of application programming interface (API) calls associated with the first set of graphics workloads, as described in connection with the examples in FIGS. 1-9. For example, as described in 910 of FIG. 9, CPU 902 may receive, prior to monitoring a first set of graphics workloads, a set of application programming interface (API) calls associated with the first set of graphics workloads. Further, step 1102 may be performed by processing unit 120 in FIG. 1.

At 1104, the CPU may configure a set of register programs for each of the set of API calls associated with the first set of graphics workloads, where the set of register programs is to be executed at the graphics processor, as described in connection with the examples in FIGS. 1-9. For example, as described in 920 of FIG. 9, CPU 902 may configure a set of register programs for each of the set of API calls associated with the first set of graphics workloads, where the set of register programs is to be executed at the graphics processor. Further, step 1104 may be performed by processing unit 120 in FIG. 1.

At 1106, the CPU may store, in a command buffer, the set of register programs for each of the set of API calls associated with the first set of graphics workloads, as described in connection with the examples in FIGS. 1-9. For example, as described in 930 of FIG. 9, CPU 902 may store, in a command buffer, the set of register programs for each of the set of API calls associated with the first set of graphics workloads. Further, step 1106 may be performed by processing unit 120 in FIG. 1.

At 1108, the CPU may output, to a graphics processor, a first indication of the first set of graphics workloads prior to monitoring the first set of graphics workloads, as described in connection with the examples in FIGS. 1-9. For example, as described in 940 of FIG. 9, CPU 902 may output, to a graphics processor, a first indication of the first set of graphics workloads prior to monitoring the first set of graphics workloads. Further, step 1108 may be performed by processing unit 120 in FIG. 1. In some aspects, outputting the first indication of the first set of graphics workloads may comprise: outputting a command for each of the first set of graphics workloads. Also, outputting the command for each of the first set of graphics workloads may comprise: storing, in a command buffer, the command for each of the first set of graphics workloads based on a set of predefined conditions.

At 1110, the CPU may monitor a first set of graphics workloads that were previously submitted to a graphics processor, as described in connection with the examples in FIGS. 1-9. For example, as described in 950 of FIG. 9, CPU 902 may monitor a first set of graphics workloads that were previously submitted to a graphics processor. Further, step 1110 may be performed by processing unit 120 in FIG. 1.

At 1112, the CPU may determine whether a status of each of the first set of graphics workloads is completed or executed at the graphics processor, as described in connection with the examples in FIGS. 1-9. For example, as described in 960 of FIG. 9, CPU 902 may determine whether a status of each of the first set of graphics workloads is completed or executed at the graphics processor. Further, step 1112 may be performed by processing unit 120 in FIG. 1. In some aspects, the status of each of the first set of graphics workloads may be at least one of: a fence for each of the first set of graphics workloads or a timestamp for each of the first set of graphics workloads. Also, the determination of the status of each of the first set of graphics workloads may be based on at least one of: a render target (RT) boundary, a draw boundary, a dispatch boundary, or a resource operations boundary. Further, the determination of the status of each of the first set of graphics workloads may be associated with an application programming interface (API) call for the second set of graphics workloads.

At 1114, the CPU may configure, based on the status of at least one graphics workload of the first set of graphics workloads being completed or executed at the graphics processor, a command for each of the second set of graphics workloads prior to outputting the command for each of the second set of graphics workloads, as described in connection with the examples in FIGS. 1-9. For example, as described in 970 of FIG. 9, CPU 902 may configure, based on the status of at least one graphics workload of the first set of graphics workloads being completed or executed at the graphics processor, a command for each of the second set of graphics workloads prior to outputting the command for each of the second set of graphics workloads. Further, step 1114 may be performed by processing unit 120 in FIG. 1. In some aspects, configuring the command for each of the second set of graphics workloads may comprise: generating a command buffer packet for each of the second set of graphics workloads.

At 1116, the CPU may output, based on the status of at least one graphics workload in the first set of graphics workloads being completed or executed at the graphics processor, an indication of a second set of graphics workloads to the graphics processor, as described in connection with the examples in FIGS. 1-9. For example, as described in 980 of FIG. 9, CPU 902 may output, based on the status of at least one graphics workload in the first set of graphics workloads being completed or executed at the graphics processor, an indication of a second set of graphics workloads to the graphics processor. Further, step 1116 may be performed by processing unit 120 in FIG. 1. In some aspects, outputting the indication of the second set of graphics workloads may comprise: outputting a command for each of the second set of graphics workloads. Also, outputting the command for each of the first set of graphics workloads may comprise: storing, in a command buffer, the command for each of the second set of graphics workloads. Moreover, outputting the indication of the second set of graphics workloads may comprise: transmitting a submission of the second set of graphics workloads to the graphics processor. In some instances, the first set of graphics workloads may comprise a first graphics workload and a second graphics workload. Also, the first graphics workload and the second graphics workload may be submitted to the graphics processor prior to the second set of graphics workloads. The second set of graphics workloads may be subsequent to the first set of graphics workloads in a workload order at the graphics processor. Additionally, the at least one graphics workload may comprise a first graphics workload and a second graphics workload that were previously submitted to the graphics processor.

At 1118, the CPU may output, based on storage of the command for each of the second set of graphics workloads, a second indication of an address of the command buffer for each of the second set of graphics workloads, as described in connection with the examples in FIGS. 1-9. For example, as described in 990 of FIG. 9, CPU 902 may output, based on storage of the command for each of the second set of graphics workloads, a second indication of an address of the command buffer for each of the second set of graphics workloads. Further, step 1118 may be performed by processing unit 120 in FIG. 1. In some aspects, outputting the second indication of the address of the command buffer for each of the second set of graphics workloads may comprise: transmitting, to the graphics processor, the second indication of the address of the command buffer for each of the second set of graphics workloads.

In configurations, a method or an apparatus for graphics processing is provided. The apparatus may be a CPU (or other central processor), a GPU (or other graphics processor), a DDIC, an apparatus for graphics processing, and/or some other processor that may perform graphics processing. In aspects, the apparatus may be the processing unit 120 within the device 104, or may be some other hardware within the device 104 or another device. The apparatus, e.g., processing unit 120, may include means for monitoring a first set of graphics workloads that were previously submitted to a graphics processor. The apparatus, e.g., processing unit 120, may also include means for determining whether a status of each of the first set of graphics workloads is completed or executed at the graphics processor. The apparatus, e.g., processing unit 120, may also include means for outputting, based on the status of at least one graphics workload in the first set of graphics workloads being completed or executed at the graphics processor, an indication of a second set of graphics workloads to the graphics processor. The apparatus, e.g., processing unit 120, may also include means for outputting, based on storage of the command for each of the second set of graphics workloads, a second indication of an address of the command buffer for each of the second set of graphics workloads. The apparatus, e.g., processing unit 120, may also include means for configuring, based on the status of the at least one graphics workload of the first set of graphics workloads being completed or executed at the graphics processor, the command for each of the second set of graphics workloads prior to outputting the command for each of the second set of graphics workloads. The apparatus, e.g., processing unit 120, may also include means for receiving, prior to monitoring the first set of graphics workloads, a set of application programming interface (API) calls associated with the first set of graphics workloads. The apparatus, e.g., processing unit 120, may also include means for configuring a set of register programs for each of the set of API calls associated with the first set of graphics workloads, where the set of register programs is to be executed at the graphics processor. The apparatus, e.g., processing unit 120, may also include means for storing, in a command buffer, the set of register programs for each of the set of API calls associated with the first set of graphics workloads. The apparatus, e.g., processing unit 120, may also include means for outputting, to the graphics processor, a first indication of the first set of graphics workloads prior to monitoring the first set of graphics workloads.

The subject matter described herein may be implemented to realize one or more benefits or advantages. For instance, the described graphics processing techniques may be used by a CPU, a central processor, a GPU, or some other processor that may perform graphics processing to implement the graphics workload submission techniques described herein. This may also be accomplished at a low cost compared to other graphics processing techniques. Moreover, the graphics processing techniques herein may improve or speed up graphics processing or execution. Further, the graphics processing techniques herein may improve resource or data utilization and/or resource efficiency. Additionally, aspects of the present disclosure may utilize graphics workload submission techniques in order to improve memory bandwidth efficiency and/or increase processing speed at a CPU, a GPU, or a DPU.

It is understood that the specific order or hierarchy of blocks in the processes / flowcharts disclosed is an illustration of example approaches. Based upon design preferences, it is understood that the specific order or hierarchy of blocks in the processes / flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. By way of example, and not limitation, such computer-readable media may comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is an apparatus for graphics processing, including at least one memory and at least one processor coupled to the at least one memory and, based at least in part on information stored in the at least one memory, the at least one processor, individually or in any combination, is configured to: monitor a first set of graphics workloads that were previously submitted to a graphics processor; determine whether a status of each of the first set of graphics workloads is completed or executed at the graphics processor; and output, based on the status of at least one graphics workload in the first set of graphics workloads being completed or executed at the graphics processor, an indication of a second set of graphics workloads to the graphics processor.

Aspect 2 is the apparatus of aspect 1, wherein to output the indication of the second set of graphics workloads, the at least one processor is configured to: output a command for each of the second set of graphics workloads.

Aspect 3 is the apparatus of aspect 2, wherein to output the command for each of the first set of graphics workloads, the at least one processor is configured to: store, in a command buffer, the command for each of the second set of graphics workloads.

Aspect 4 is the apparatus of aspect 3, wherein the at least one processor is further configured to: output, based on storage of the command for each of the second set of graphics workloads, a second indication of an address of the command buffer for each of the second set of graphics workloads.

Aspect 5 is the apparatus of aspect 4, wherein to output the second indication of the address of the command buffer for each of the second set of graphics workloads, the at least one processor is configured to: transmit, to the graphics processor, the second indication of the address of the command buffer for each of the second set of graphics workloads.

Aspect 6 is the apparatus of any of aspects 2 to 5, wherein the at least one processor is further configured to: configure, based on the status of the at least one graphics workload of the first set of graphics workloads being completed or executed at the graphics processor, the command for each of the second set of graphics workloads prior to output of the command for each of the second set of graphics workloads.

Aspect 7 is the apparatus of aspect 6, wherein to configure the command for each of the second set of graphics workloads, the at least one processor is configured to: generate a command buffer packet for each of the second set of graphics workloads.

Aspect 8 is the apparatus of any of aspects 1 to 7, wherein to output the indication of the second set of graphics workloads, the at least one processor is configured to: transmit a submission of the second set of graphics workloads to the graphics processor.

Aspect 9 is the apparatus of any of aspects 1 to 8, wherein the at least one processor is further configured to: receive, prior to the monitor of the first set of graphics workloads, a set of application programming interface (API) calls associated with the first set of graphics workloads.

Aspect 10 is the apparatus of aspect 9, wherein the at least one processor is further configured to: configure a set of register programs for each of the set of API calls associated with the first set of graphics workloads, wherein the set of register programs is to be executed at the graphics processor.

Aspect 11 is the apparatus of aspect 10, wherein the at least one processor is further configured to: store, in a command buffer, the set of register programs for each of the set of API calls associated with the first set of graphics workloads.

Aspect 12 is the apparatus of any of aspects 1 to 11, wherein the at least one processor is further configured to: output, to the graphics processor, a first indication of the first set of graphics workloads prior to monitoring the first set of graphics workloads.

Aspect 13 is the apparatus of aspect 12, wherein to output the first indication of the first set of graphics workloads, the at least one processor is configured to: output a command for each of the first set of graphics workloads.

Aspect 14 is the apparatus of aspect 13, wherein to output the command for each of the first set of graphics workloads, the at least one processor is configured to: store, in a command buffer, the command for each of the first set of graphics workloads based on a set of predefined conditions.

Aspect 15 is the apparatus of any of aspects 1 to 14, wherein the status of each of the first set of graphics workloads is at least one of: a fence for each of the first set of graphics workloads or a timestamp for each of the first set of graphics workloads.

Aspect 16 is the apparatus of any of aspects 1 to 15, wherein the determination of the status of each of the first set of graphics workloads is based on at least one of: a render target (RT) boundary, a draw boundary, a dispatch boundary, or a resource operations boundary.

Aspect 17 is the apparatus of any of aspects 1 to 16, wherein the determination of the status of each of the first set of graphics workloads is associated with an application programming interface (API) call for the second set of graphics workloads.

Aspect 18 is the apparatus of any of aspects 1 to 17, wherein the first set of graphics workloads comprises a first graphics workload and a second graphics workload, and wherein the first graphics workload and the second graphics workload were submitted to the graphics processor prior to the second set of graphics workloads.

Aspect 19 is the apparatus of any of aspects 1 to 18, wherein the second set of graphics workloads is subsequent to the first set of graphics workloads in a workload order at the graphics processor.

Aspect 20 is the apparatus of any of aspects 1 to 19, wherein the at least one graphics workload comprises a first graphics workload and a second graphics workload that were previously submitted to the graphics processor.

Aspect 21 is the apparatus of any of aspects 1 to 20, further including (i.e., comprising) at least one of an antenna or a transceiver coupled to the at least one processor, wherein to output the indication of the second set of graphics workloads to the graphics processor, the at least one processor, individually or in any combination, is configured to: transmit, via at least one of the antenna or the transceiver, the indication of the second set of graphics workloads to the graphics processor.

Aspect 22 is the apparatus of any of aspects 1 to 20, wherein the apparatus is a wireless communication device.

Aspect 23 is a method of graphics processing for implementing any of aspects 1 to 22.

Aspect 24 is an apparatus for graphics processing including means for implementing any of aspects 1 to 22.

Aspect 25 is a computer-readable medium (e.g., a non-transitory computer-readable medium) storing computer executable code (e.g., code for graphics processing), the code when executed by at least one processor causes the at least one processor to implement any of aspects 1 to 22.

What is claimed is:

1. An apparatus for graphics processing, comprising:
a first memory; and
a processor coupled to the first memory and, based at least in part on information stored in the first memory, the processor is configured to:
monitor a first set of graphics workloads that were previously submitted to a graphics processor;
determine whether a status of each of the first set of graphics workloads is completed or executed at the graphics processor; and
output, based on the status of at least one graphics workload in the first set of graphics workloads being completed or executed at the graphics processor, an indication of a second set of graphics workloads to the graphics processor.

2. The apparatus of claim 1, wherein to output the indication of the second set of graphics workloads, the processor is configured to: output a command for each of the second set of graphics workloads.

3. The apparatus of claim 2, wherein to output the command for each of the first set of graphics workloads, the processor is configured to: store, in a command buffer, the command for each of the second set of graphics workloads.

4. The apparatus of claim 3, wherein the processor is further configured to:
output, based on storage of the command for each of the second set of graphics workloads, a second indication of an address of the command buffer for each of the second set of graphics workloads.

5. The apparatus of claim 4, wherein to output the second indication of the address of the command buffer for each of the second set of graphics workloads, the processor is configured to: transmit, to the graphics processor, the second indication of the address of the command buffer for each of the second set of graphics workloads.

6. The apparatus of claim 2, wherein the processor is further configured to:
configure, based on the status of the at least one graphics workload of the first set of graphics workloads being completed or executed at the graphics processor, the command for each of the second set of graphics workloads prior to output of the command for each of the second set of graphics workloads.

7. The apparatus of claim 6, wherein to configure the command for each of the second set of graphics workloads, the processor is configured to: generate a command buffer packet for each of the second set of graphics workloads.

8. The apparatus of claim 1, wherein to output the indication of the second set of graphics workloads, the processor is configured to: transmit a submission of the second set of graphics workloads to the graphics processor.

9. The apparatus of claim 1, wherein the processor is further configured to:
receive, prior to the monitor of the first set of graphics workloads, a set of application programming interface (API) calls associated with the first set of graphics workloads.

10. The apparatus of claim 9, wherein the processor is further configured to:
configure a set of register programs for each of the set of API calls associated with the first set of graphics workloads, wherein the set of register programs is to be executed at the graphics processor.

11. The apparatus of claim 10, wherein the processor is further configured to:
store, in a command buffer, the set of register programs for each of the set of API calls associated with the first set of graphics workloads.

12. The apparatus of claim 1, wherein the processor is further configured to:
output, to the graphics processor, a first indication of the first set of graphics workloads prior to the monitor of the first set of graphics workloads.

13. The apparatus of claim 12, wherein to output the first indication of the first set of graphics workloads, the processor is configured to: output a command for each of the first set of graphics workloads.

14. The apparatus of claim 13, wherein to output the command for each of the first set of graphics workloads, the processor is configured to: store, in a command buffer, the command for each of the first set of graphics workloads based on a set of predefined conditions.

15. The apparatus of claim 1, wherein the status of each of the first set of graphics workloads is at least one of: a fence for each of the first set of graphics workloads or a timestamp for each of the first set of graphics workloads.

16. The apparatus of claim 1, wherein the determination of the status of each of the first set of graphics workloads is based on at least one of: a render target (RT) boundary, a draw boundary, a dispatch boundary, or a resource operations boundary, or wherein the determination of the status of each of the first set of graphics workloads is associated with an application programming interface (API) call for the second set of graphics workloads.

17. The apparatus of claim 1, wherein the first set of graphics workloads comprises a first graphics workload and a second graphics workload, and wherein the first graphics workload and the second graphics workload were submitted to the graphics processor prior to the second set of graphics workloads.

18. The apparatus of claim 1, wherein the second set of graphics workloads is subsequent to the first set of graphics workloads in a workload order at the graphics processor, and wherein the at least one graphics workload comprises a first graphics workload and a second graphics workload that were previously submitted to the graphics processor.

19. A method of graphics processing, comprising:
monitoring a first set of graphics workloads that were previously submitted to a graphics processor;
determining whether a status of each of the first set of graphics workloads is completed or executed at the graphics processor; and
outputting, based on the status of at least one graphics workload in the first set of graphics workloads being completed or executed at the graphics processor, an indication of a second set of graphics workloads to the graphics processor.

20. A computer-readable medium storing computer executable code for graphics processing, the code when executed by a processor causes the processor to:
monitor a first set of graphics workloads that were previously submitted to a graphics processor;
determine whether a status of each of the first set of graphics workloads is completed or executed at the graphics processor; and
output, based on the status of at least one graphics workload in the first set of graphics workloads being completed or executed at the graphics processor, an indication of a second set of graphics workloads to the graphics processor.
